(19) United States
(12) Patent Application Publication
(10) Pub. No.: US 2025/0237386 A1
(43) Pub. Date: Jul. 24, 2025

(54) PORTABLE GRILLS

(71) Applicant: Weber-Stephen Barbecue Products (Shenzhen) Company Limited, Shenzhen (CN)

(72) Inventors: Robert Lin, Huizhou (CN); Robert J. Farmer, Naperville, IL (US); Paul R. Hunt, Lake Zurich, IL (US)

(21) Appl. No.: 18/742,471

(22) Filed: Jun. 13, 2024

Related U.S. Application Data
(63) Continuation of application No. PCT/CN2024/073765, filed on Jan. 24, 2024.

(51) Int. Cl. F24C 1/16; A47J 37/07; F24C 3/12; F24C 15/08

(52) U.S. Cl. CPC F24C 1/16; A47J 37/0713; A47J 37/0763; F24C 3/126; F24C 15/086; A47J 2037/0777

(57) ABSTRACT

Portable grills are disclosed. An example portable grill configured to be transitioned between an erected configuration and a collapsed configuration includes a frame, a first leg unit, and a second leg unit. The frame supports a cookbox. The first leg unit is pivotally coupled to the frame. The second leg unit is pivotally coupled to the frame and pivotally coupled to the first leg unit. The first leg unit and the second leg unit each include a front leg and a rear leg, with the rear leg being spaced apart from the front leg. The front leg and the rear leg of the second leg unit each include a first segment, a second segment, and a hinge located between the first segment and the second segment. The hinge of each leg pivotally couples the first segment of the leg to the second segment of the leg.

### CROSS-REFERENCE TO RELATED APPLICATIONS

This application claims priority to International Patent Application No. PCT/CN2024/073765, filed Jan. 24, 2024. The entirety of International Patent Application No. PCT/CN2024/073765 is hereby incorporated by reference herein.

### FIELD OF THE DISCLOSURE

This disclosure relates generally to grills and, more specifically, to portable grills.

### BACKGROUND

Portable grills are intended to be transported from a storage location (e.g., a home, a garage, a shed, a commercial storage unit, a vehicle, etc.) to a variety of remotely-located destinations which may be suitable for using the portable grill to cook food. For example, portable grills are commonly transported to campsites, tailgating sites, hiking sites, parks, beaches, etc. for use at such destinations. Portable grills are conventionally configured to cook (e.g., grill, smoke, bake, roast, broil, sear, and/or otherwise heat) food items located within (e.g., placed on one or more cooking grate(s) positioned within) a cooking chamber of the portable grill. In some instances, the cooking chamber of the portable grill is fueled by a combustible supply of liquid petroleum gas (LP gas) that is contained under pressure within a fuel tank, with the fuel tank being removably couplable to and/or from a valve and regulator assembly of the portable grill, and/or removably couplable to and/or from one or more other mechanical structure(s) of the portable grill. In some such instances, the portable grill includes a cookbox having one or more burner tube(s) that is/are operatively coupled to the valve and regulator assembly, with the burner tube(s) being configured to generate, carry, and/or otherwise provide flames within the cookbox and/or within the cooking chamber of the portable grill in response to ignition and/or combustion of the LP gas as the LP gas flows from the fuel tank, through the valve and regulator assembly, and into the burner tube(s) of the portable grill.

Many portable grills are capable of being transitioned (e.g., via one or more foldable and/or collapsible leg(s) of the portable grill) between an erected configuration that is intended and/or purposed for cooking food, and a collapsed configuration that is intended and/or purposed for transporting and/or stowing the portable grill at a time when it is not being used to cook food. Such portable grills typically have a reduced form factor (e.g., a reduced height and/or a reduced width) when positioned in their collapsed configuration relative to the corresponding form factor when positioned in their erected configuration. In some instances, the reduced form factor associated with the collapsed configuration of the portable grill facilitates loading the portable grill into a storage compartment (e.g., a trunk, a flatbed, a cargo area, etc.) of a vehicle. In some such instances, the portable grill may be unable to fit within the storage compartment when the portable grill is positioned in the erected configuration, but is able to fit within the storage compartment when the portable grill is positioned in the collapsed configuration.

### BRIEF DESCRIPTION OF THE DRAWINGS

FIG. 1 is a first perspective view of an example portable grill constructed in accordance with teachings of this disclosure, with the portable grill shown in an example erected configuration.

FIG. 2 is a second perspective view of the portable grill as shown in FIG. 1.

FIG. 3 is a front view of the portable grill as shown in FIGS. 1 and 2.

FIG. 4 is a rear view of the portable grill as shown in FIGS. 1-3.

FIG. 5 is a right side view of the portable grill as shown in FIGS. 1-4.

FIG. 6 is a left side view of the portable grill as shown in FIGS. 1-5.

FIG. 7 is a top view of the portable grill as shown in FIGS. 1-6.

FIG. 8 is a bottom view of the portable grill as shown in FIGS. 1-7.

FIG. 9 is a first perspective view of the portable grill of FIGS. 1-8, with the portable grill shown in an example collapsed configuration.

FIG. 10 is a second perspective view of the portable grill as shown in FIG. 9.

FIG. 11 is a front view of the portable grill as shown in FIGS. 9 and 10.

FIG. 12 is a perspective view of the first leg unit of the portable grill of FIGS. 1-11 shown in isolation, with the first leg unit shown in the erected configuration of FIGS. 1-8.

FIG. 13 is a perspective view of the second leg unit of the portable grill of FIGS. 1-11 shown in isolation, with the second leg unit shown in the erected configuration of FIGS. 1-8.

FIG. 14 is a front view of a portion of the rear leg of the second leg unit of FIGS. 1-11 and 13, with the rear leg of the second leg unit shown in the erected configuration of FIGS. 1-8 and 13, with the first segment of the rear leg shown in phantom to enhance the viewability of a portion of the leg lock assembly of the portable grill, and with an example plunger of the leg lock assembly shown in an example locked position.

FIG. 15 is a cross-sectional view of a portion of the rear leg of the second leg unit of FIGS. 1-11, 13 and 14, with the rear leg of the second leg unit shown in the erected configuration of FIGS. 1-8, 13, and 14, and with the plunger of the leg lock assembly shown in the locked position of FIG. 14.

FIG. 16 is a front view of a portion of the rear leg of the second leg unit of FIGS. 1-11 and 13-15, with the rear leg of the second leg unit shown in the erected configuration of FIGS. 1-8 and 13-15, with the first segment of the rear leg shown in phantom to enhance the viewability of a portion of the leg lock assembly of the portable grill, and with the plunger of the leg lock assembly shown in an example unlocked position.

FIG. 17 is a cross-sectional view of a portion of the rear leg of the second leg unit of FIGS. 1-11 and 13-16, with the rear leg of the second leg unit shown in the erected configuration of FIGS. 1-8 and 13-16, and with the plunger of the leg lock assembly shown in the unlocked position of FIG. 16.

FIG. 18 is a first perspective view of a portion of the portable grill of FIGS. 1-11, with the rear leg of the second leg unit of the portable grill shown in the erected configuration of FIGS. 1-8 and 13-17, and with the leg lock assembly of the portable grill shown in an example locked configuration.

FIG. 19 is a second perspective view of the portion of the portable grill as shown in FIG. 18.

FIG. 20 is a front view of the portion of the portable grill as shown in FIGS. 18 and 19.

FIG. 21 is a rear view of the portion of the portable grill as shown in FIGS. 18-20.

FIG. 22 is a top view of the portion of the portable grill as shown in FIGS. 18-21.

FIG. 23 is a cross-sectional view of the portion of the portable grill as shown in FIGS. 18-22.

FIG. 24 is a first perspective view of a portion of the portable grill of FIGS. 1-11, with the rear leg of the second leg unit of the portable grill shown in the erected configuration of FIGS. 1-8 and 13-23, and with the leg lock assembly of the portable grill shown in an example partially unlocked configuration.

FIG. 25 is a second perspective view of the portion of the portable grill as shown in FIG. 24.

FIG. 26 is a front view of the portion of the portable grill as shown in FIGS. 24 and 25.

FIG. 27 is a rear view of the portion of the portable grill as shown in FIGS. 24-26.

FIG. 28 is a top view of the portion of the portable grill as shown in FIGS. 24-27.

FIG. 29 is a cross-sectional view of the portion of the portable grill as shown in FIGS. 24-28.

FIG. 30 is a first perspective view of a portion of the portable grill of FIGS. 1-11, with the rear leg of the second leg unit of the portable grill shown in the erected configuration of FIGS. 1-8 and 13-29, and with the leg lock assembly of the portable grill shown in an example unlocked configuration.

FIG. 31 is a second perspective view of the portion of the portable grill as shown in FIG. 30.

FIG. 32 is a front view of the portion of the portable grill as shown in FIGS. 30 and 31.

FIG. 33 is a rear view of the portion of the portable grill as shown in FIGS. 30-32.

FIG. 34 is a top view of the portion of the portable grill as shown in FIGS. 30-33.

FIG. 35 is a cross-sectional view of the portion of the portable grill as shown in FIGS. 30-34.

FIG. 36 is a first perspective view of a portion of the portable grill of FIGS. 1-11, with the rear leg of the second leg unit of the portable grill shown in the collapsed configuration of FIGS. 9-11.

FIG. 37 is a second perspective view of the portion of the portable grill as shown in FIG. 37.

FIG. 38 is a front view of the portion of the portable grill as shown in FIGS. 37 and 38.

FIG. 39 is a rear view of the portion of the portable grill as shown in FIGS. 37-39.

FIG. 40 is a top view of the portion of the portable grill as shown in FIGS. 37-40.

FIG. 41 is a cross-sectional view of the portion of the portable grill as shown in FIGS. 37-41.

FIG. 42 is a first perspective view of a portion of the portable grill of FIGS. 1-11, with the leg lock assembly of the portable grill shown in the locked configuration of FIGS. 18-23, and with the tank blocker of the portable grill shown in an example non-blocking position.

FIG. 43 is a second perspective view of the portion of the portable grill as shown in FIG. 42.

FIG. 44 is a first perspective view of a portion of the portable grill of FIGS. 1-11, with the leg lock assembly of the portable grill shown in the locked configuration of FIGS. 18-23, 42, and 43, and with the tank blocker of the portable grill shown in an example blocking position.

FIG. 45 is a second perspective view of the portion of the portable grill as shown in FIG. 44.

FIG. 46 is a first perspective view of a portion of the portable grill of FIGS. 1-11, with the leg lock assembly of the portable grill shown in the locked configuration of FIGS. 18-23 and 42-45, and with the tank blocker of the portable grill shown in the non-blocking position of FIGS. 42 and 43.

FIG. 47 is a second perspective view of the portion of the portable grill as shown in FIG. 46.

FIG. 48 is a first perspective view of a portion of the portable grill of FIGS. 1-11, with the leg lock assembly of the portable grill shown in the partially unlocked configuration of FIGS. 24-29, and with the tank blocker of the portable grill shown in the non-blocking position of FIGS. 42, 43, 46, and 47.

FIG. 49 is a second perspective view of the portion of the portable grill as shown in FIG. 48.

FIG. 50 is a first perspective view of a portion of the portable grill of FIGS. 1-11, with the leg lock assembly of the portable grill shown in the unlocked configuration of FIGS. 30-35, and with the tank blocker of the portable grill shown in the non-blocking position of FIGS. 42, 43, and 46-49.

FIG. 51 is a second perspective view of the portion of the portable grill as shown in FIG. 50.

FIG. 52 is a first perspective view of a portion of the portable grill of FIGS. 1-11, with the rear leg of the second leg unit shown in the collapsed configuration of FIGS. 9-11 and 36-41, and with the tank blocker of the portable grill shown in the non-blocking position of FIGS. 42, 43, and 46-51.

FIG. 53 is a second perspective view of the portion of the portable grill as shown in FIG. 52.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As discussed above, many portable grills are capable of being transitioned (e.g., via one or more foldable and/or collapsible leg(s) of the portable grill) between an erected configuration that is intended and/or purposed for cooking food, and a collapsed configuration that is intended and/or purposed for transporting and/or stowing the portable grill at a time when it is not being used to cook food. Examples of such known portable grills are disclosed in U.S. Pat. Nos. 11,503,950, 11,503,951, 11,503,952, 11,510,525, 11,510,526, 11,571,087, and 11,571,088, the entireties of which are hereby incorporated by reference herein.

Example portable grills disclosed herein include hinged legs that advantageously enable the portable grill to have a compact form factor. For example, the hinged legs of the portable grills disclosed herein provide for a portable grill having a form factor that is reduced in size relative to a corresponding form factor of the portable grills disclosed in U.S. Pat. Nos. 11,503,950, 11,503,951, 11,503,952, 11,510,525, 11,510,526, 11,571,087, and/or 11,571,088. The reduced form factor attributable to the hinged legs of the disclosed portable grills advantageously enhances the overall portability of such disclosed portable grills relative to the portability of know portable grills that lack such hinged legs.

Example portable grills disclosed herein further include a leg lock assembly configured to lock a position of one or more hinged leg(s) of the portable grill (e.g., relative to a frame of the portable grill) when the portable grill is positioned in an erected configuration. In some examples, the leg lock assembly of the disclosed portable grills includes a handle configured to unlock and/or release the locked position of the hinged leg(s) of the portable grill in response to actuation of the handle by a user of the portable grill. In some examples, the handle is actuatable to unlock and/or release the locked position of the hinged leg(s) of the portable grill when the portable grill is in the erected configuration. In some examples, actuation of the handle facilitates transitioning the portable grill from the erected configuration into the collapsed configuration.

Example portable grills disclosed herein further include a tank blocker configured to restrict (e.g., prevent) the portable grill from being transitioned from the erected configuration into the collapsed configuration when a fuel tank that is removably couplable to and/or from the portable grill remains coupled to the portable grill. In some examples, the tank blocker is operatively coupled to the above-described leg lock assembly such that movement of the tank blocker from a blocking position (e.g., which prevents an upward movement of a lever and/or the handle of the leg lock assembly) into a non-blocking position (e.g., which enables the upward movement of the lever and/or the handle of the leg lock assembly) occurs automatically in response to the attached fuel tank becoming uncoupled and/or detached from the portable grill. Thus, the tank blocker advantageously provides a mechanically-automated failsafe against the possibility of a user of the portable grill failing to uncouple and/or remove the fuel tank from the portable grill prior to initiating the transition of the portable grill from the erected configuration into the collapsed configuration.

The above-identified features as well as other advantageous features of the disclosed portable grills are further described below in connection with the figures of the application.

As used herein, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

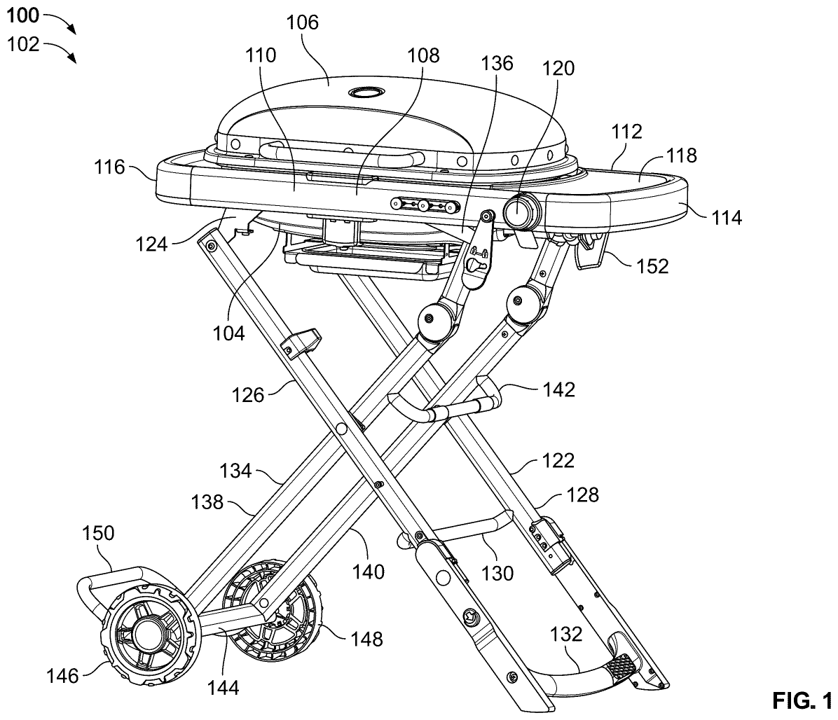

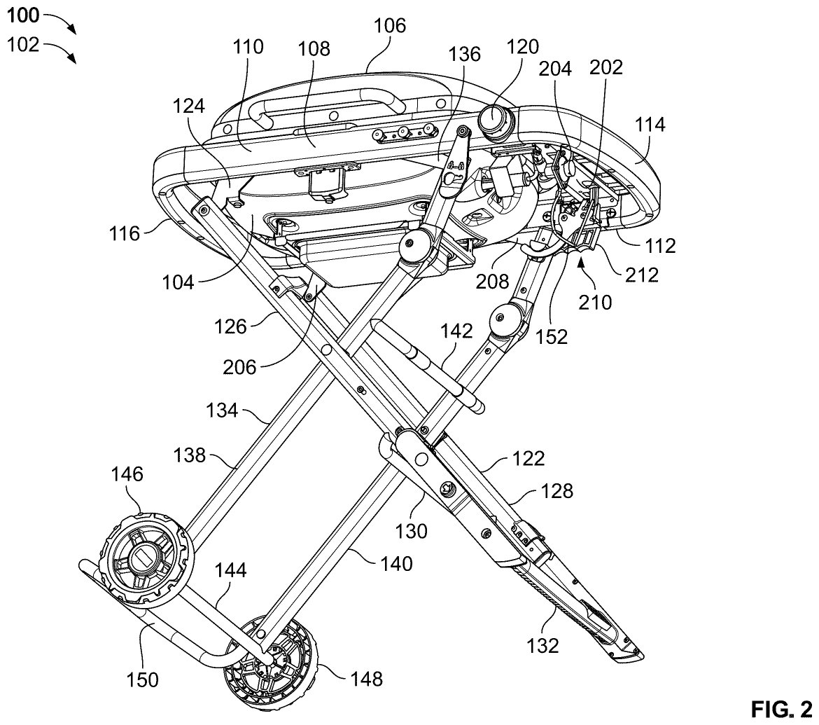

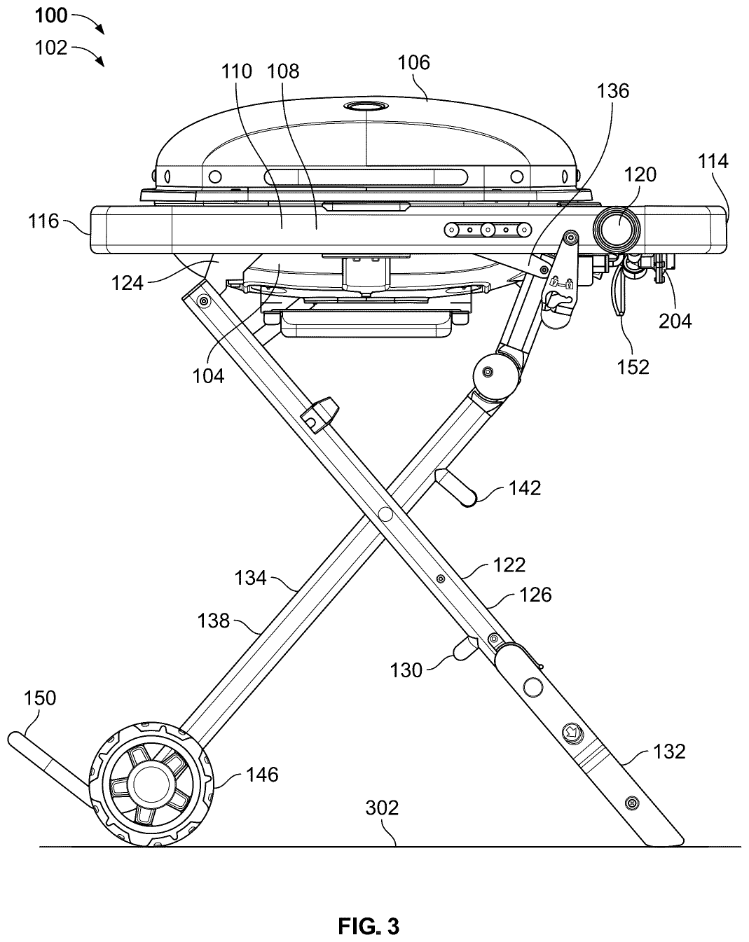

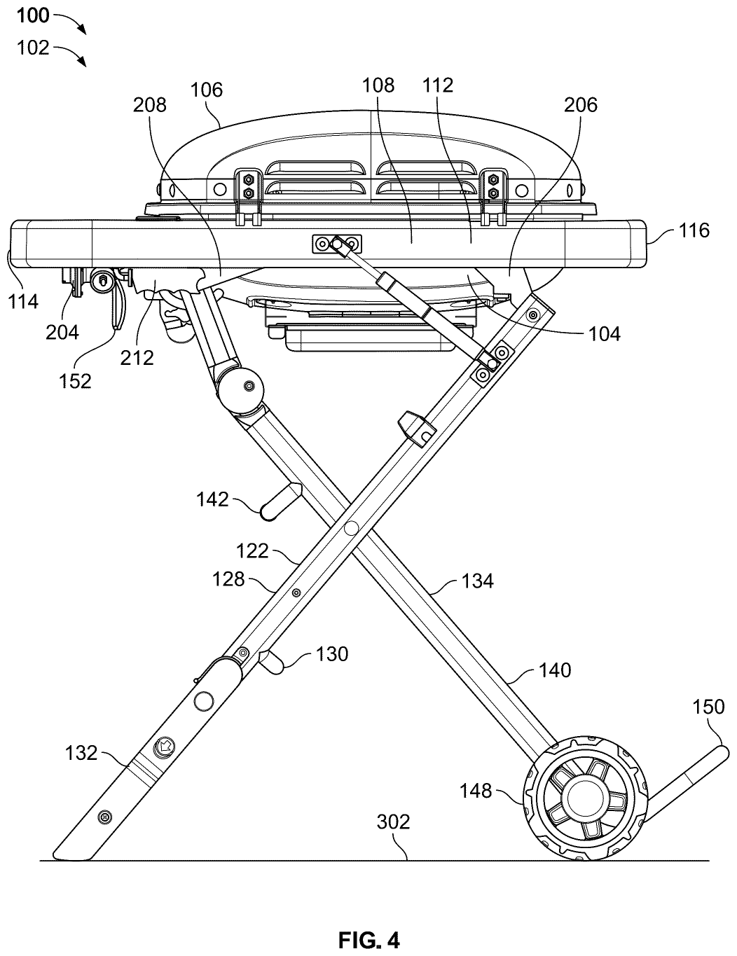

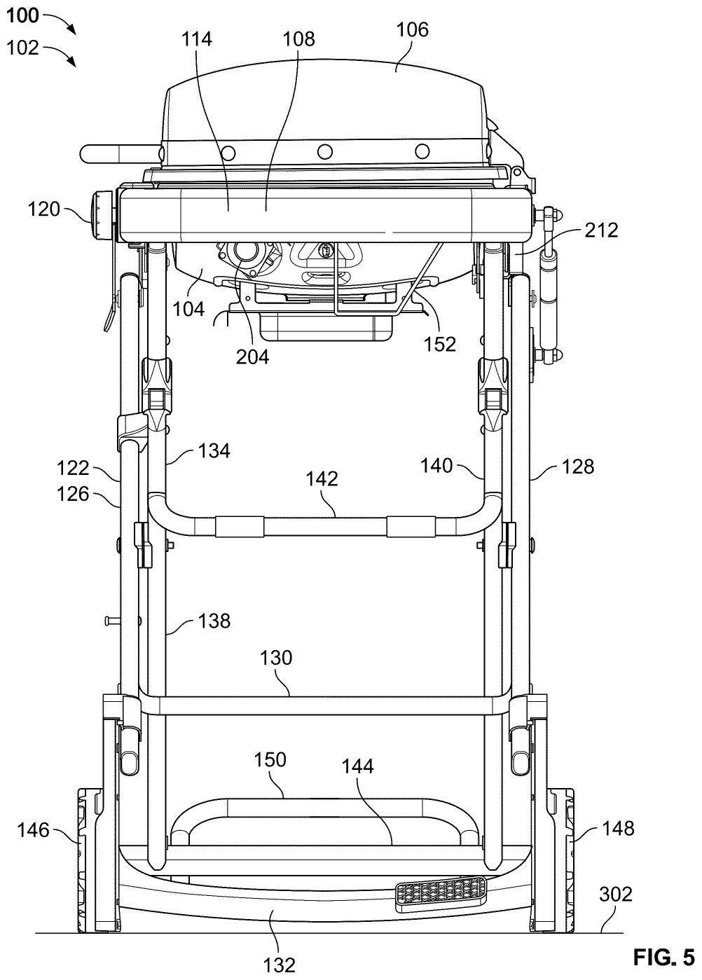

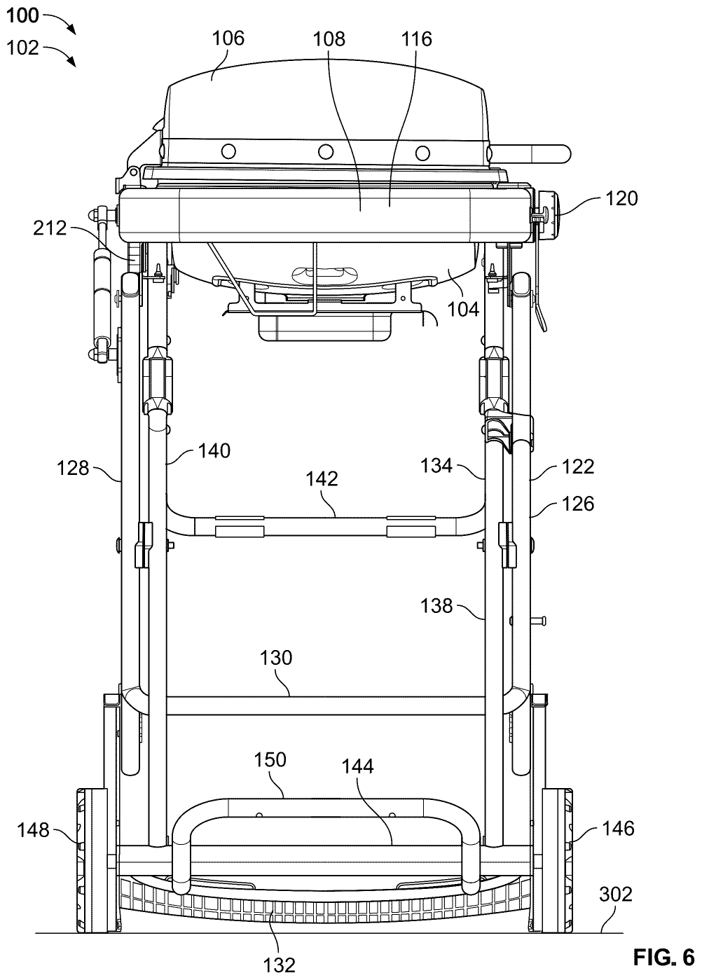

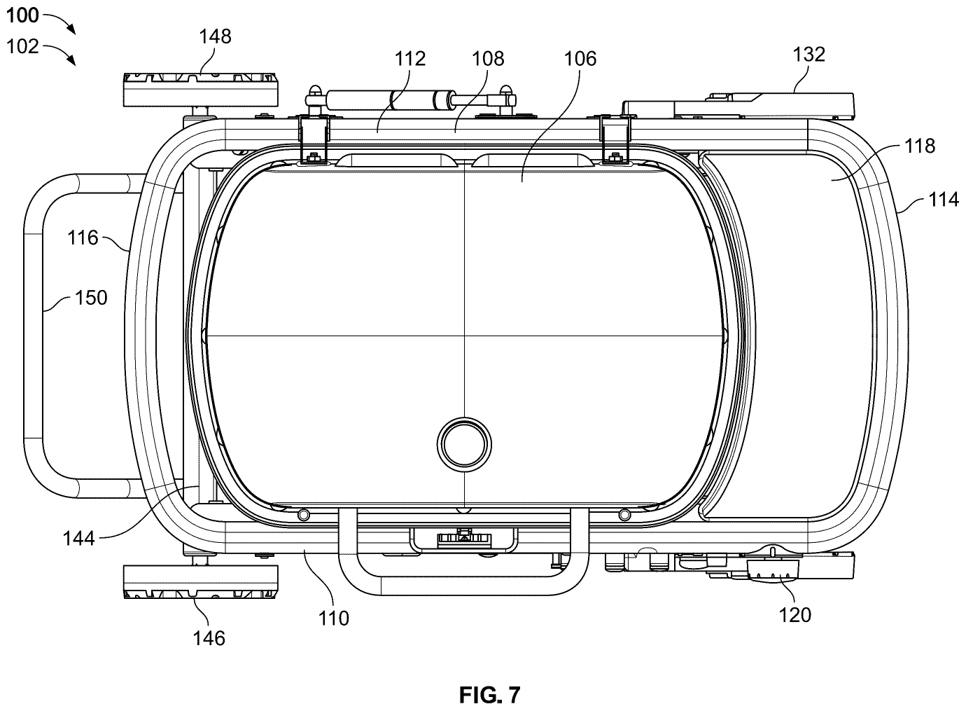

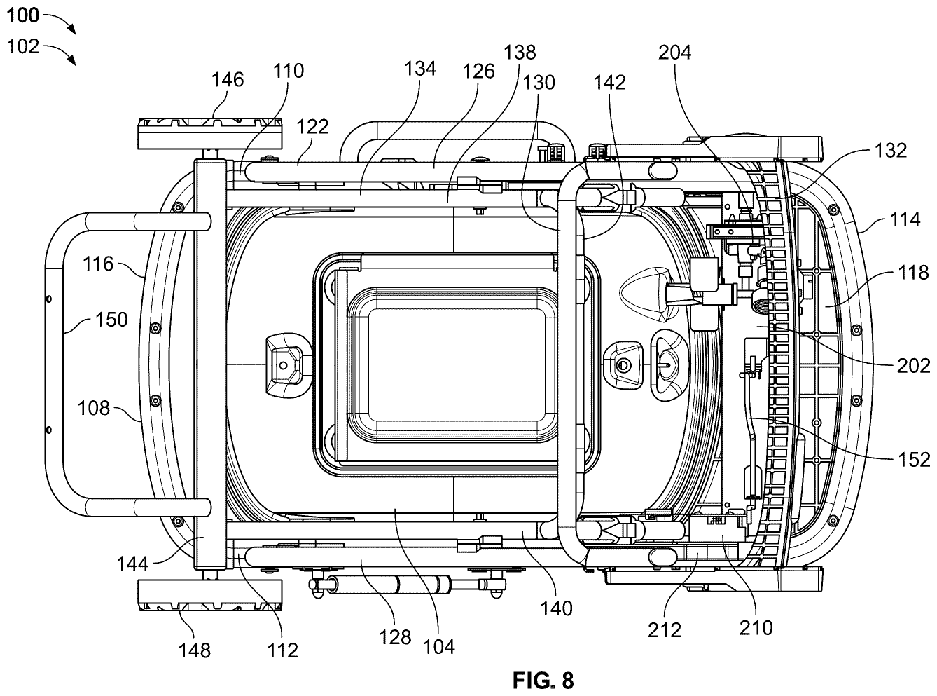

FIG. 1 is a first perspective view of an example portable grill 100 constructed in accordance with teachings of this disclosure, with the portable grill 100 shown in an example erected configuration 102. FIG. 2 is a second perspective view of the portable grill 100 as shown in FIG. 1. FIG. 3 is a front view of the portable grill 100 as shown in FIGS. 1 and 2. FIG. 4 is a rear view of the portable grill 100 as shown in FIGS. 1-3. FIG. 5 is a right side view of the portable grill 100 as shown in FIGS. 1-4. FIG. 6 is a left side view of the portable grill 100 as shown in FIGS. 1-5. FIG. 7 is a top view of the portable grill 100 as shown in FIGS. 1-6. FIG. 8 is a bottom view of the portable grill 100 as shown in FIGS. 1-7.

The portable grill 100 is configured to be positioned in the erected configuration 102 shown in FIGS. 1-8 while the portable grill 100 is being used to cook one or more food item(s). As shown in FIGS. 3-6, the portable grill 100 can be located on and/or supported by an example underlying surface 302 (e.g., a ground surface, a floor surface, etc.) when the portable grill 100 is positioned in the erected configuration 102. In the illustrated example of FIGS. 3-6, the portable grill 100 is shown positioned in the erected configuration 102 and oriented horizontally (e.g., parallel) relative to the underlying surface 302, as further described below.

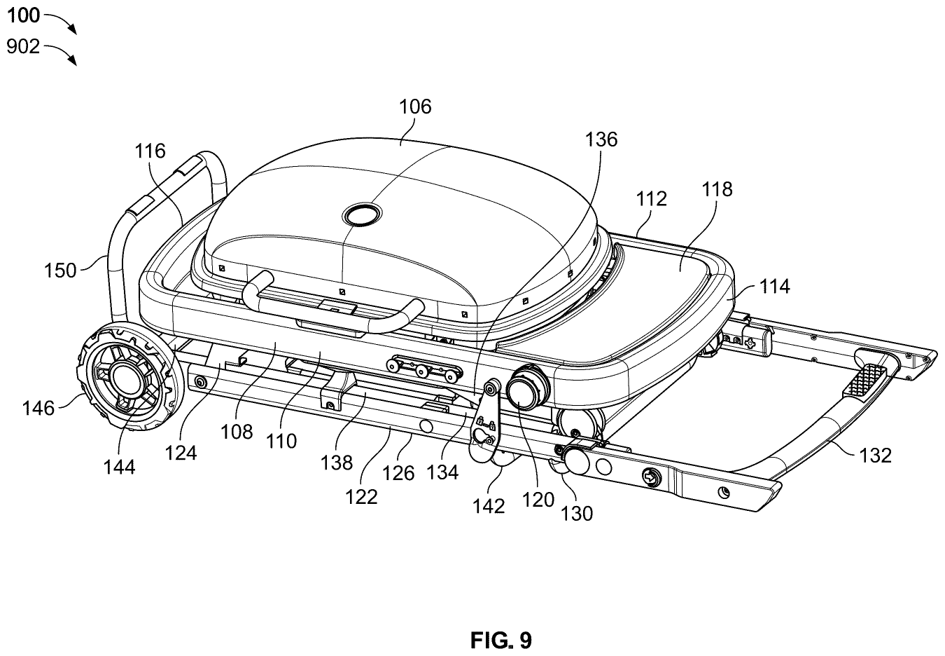

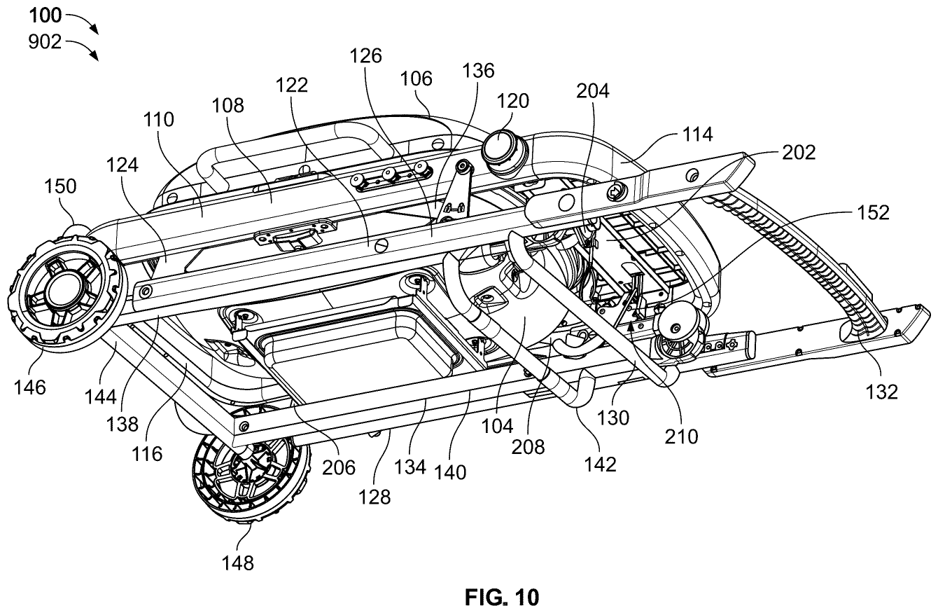

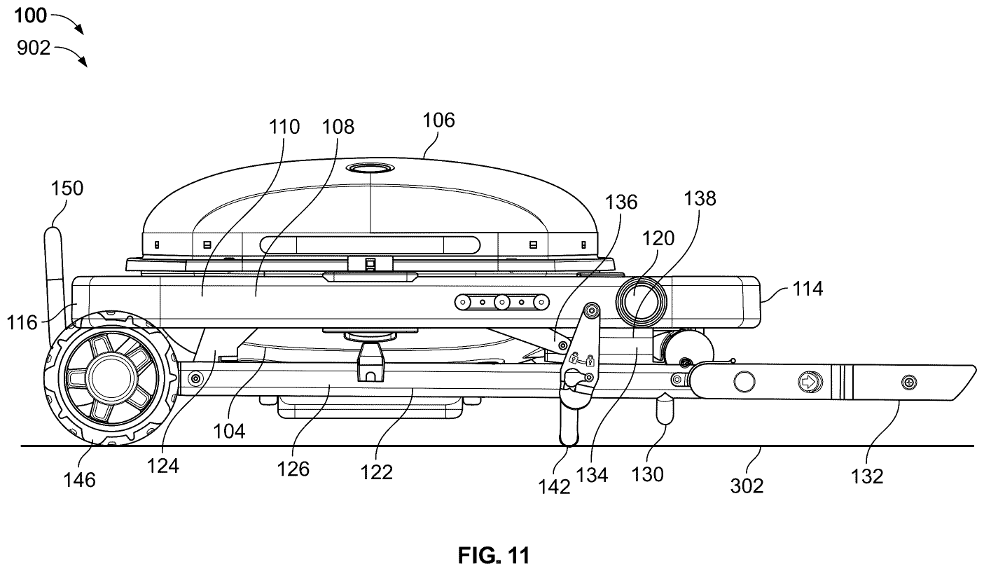

The portable grill 100 of FIGS. 1-8 can be moved (e.g., transitioned) from the erected configuration 102 shown in FIGS. 1-8 into an example collapsed configuration 902 shown in FIGS. 9-11, and vice versa. FIG. 9 is a first perspective view of the portable grill 100 of FIGS. 1-8, with the portable grill 100 shown in the collapsed configuration 902. FIG. 10 is a second perspective view of the portable grill 100 as shown in FIG. 9. FIG. 11 is a front view of the portable grill 100 as shown in FIGS. 9 and 10.

The portable grill 100 is configured to be positioned in the collapsed configuration 902 shown in FIGS. 9-11 while the portable grill 100 is being transported from one location to another, and/or while the portable grill 100 is being stowed. As shown in FIG. 11, the portable grill 100 can be located on and/or supported by the underlying surface 302 when the portable grill 100 is positioned in the collapsed configuration 902. In the illustrated example of FIG. 11, the portable grill 100 is shown positioned in the collapsed configuration 902 and oriented horizontally (e.g., parallel) relative to the underlying surface 302, as further described below.

The portable grill 100 of FIGS. 1-11 includes an example cookbox 104 and an example lid 106. The lid 106 is movably coupled to the cookbox 104 via one or more hinge(s) that enable the lid 106 to be moved (e.g., pivoted and/or rotated) relative to the cookbox 104 between a closed position (e.g., as shown in FIGS. 1-11) and an open position. The cookbox 104 and the lid 106 collectively define a cooking chamber of the portable grill 100 when the lid 106 is in the closed position. Placement of the lid 106 in the open position enables a user to access the cookbox 104 and/or the cooking chamber, as may be required to load, unload, and/or otherwise access one or more food item(s) located thereon or therein. Movement of the lid 106 between the closed position and the open position can be performed by a user of the portable grill 100 via a handle coupled to the lid 106. In some examples, the orientation of the cookbox 104 of the portable grill 100 relative to the underlying surface 302 defines and/or constitutes the orientation of the portable grill 100. For example, as shown in FIGS. 3-6 and 11, the cookbox 104, and therefore the portable grill 100, is oriented horizontally (e.g., parallel) relative to the underlying surface 302.

The portable grill 100 of FIGS. 1-11 further includes an example frame 108. The cookbox 104 of the portable grill 100 is circumscribed by the frame 108 and is rigidly coupled thereto such that the cookbox 104 and the frame 108 move in a unitary manner (e.g., in connection with transitioning the portable grill 100 from the erected configuration 102 into the collapsed configuration 902). In the illustrated example of FIGS. 1-11, the cookbox 104 is asymmetrically located and/or positioned within a boundary formed by the frame 108. More specifically, the cookbox 104 is located and/or positioned closer to the left side of the frame 108 than to the right side of the frame 108. In other examples, the cookbox 104 can instead be asymmetrically located and/or positioned within the frame 108 such that the cookbox 104 is instead located and/or positioned closer to the right side of the frame 108 than to the left side of the frame 108. In still other examples, the cookbox 104 can instead be centrally located and/or positioned within the frame 108 such that the cookbox 104 is located and/or positioned in an equidistant manner relative to the right and left sides of the frame 108. In some examples, the orientation of the frame 108 of the portable grill 100 relative to the underlying surface 302 defines and/or constitutes the orientation of the portable grill 100. For example, as shown in FIGS. 3-6 and 11, the frame 108, and therefore the portable grill 100, is oriented horizontally (e.g., parallel) relative to the underlying surface 302.

In the illustrated example of FIGS. 1-11, the frame 108 is formed by a plurality of frame rails including an example front rail 110, an example rear rail 112, an example right side rail 114, and an example left side rail 116. The rear rail 112 is spaced apart from the front rail 110, and the left side rail 116 is spaced apart from the right side rail 114. The front rail 110 is coupled (e.g., via one or more fastener(s) and/or interlocking member(s)) to the right side rail 114 and the left side rail 116. The rear rail 112 is similarly coupled (e.g., via one or more fastener(s) and/or interlocking member(s)) to the right side rail 114 and the left side rail 116. In other examples, two or more of the above-identified rail(s) of the frame 108 can be integrally formed with one another.

In the illustrated example of FIGS. 1-11, one or more portion(s) of the frame 108 (e.g., one or more portion(s) of the front rail 110, the rear rail 112, the right side rail 114, and/or the left side rail 116) is/are hollow. In some examples, the hollow portion(s) of the frame 108 is/are configured to receive, contain, support, and/or carry one or more portion(s) of one or more other component(s) of the portable grill 100. For example, the hollow portion(s) of the frame 108 can receive, contain, support, and/or carry one or more portion(s) of one or more component(s) of any of a first leg unit, a second leg unit, and/or a leg lock assembly, as further described below. In some examples, the received, contained, supported, and/or carried portion(s) of the component(s) is/are movable (e.g., translatable and/or rotatable) within the hollow portion(s) of the frame 108. In some examples, locating and/or positioning the portion(s) of the component(s) within the hollow portion(s) of the frame 108 partially or fully conceals the portion(s) of the component(s) from exposure, thereby advantageously reducing wear on, and/or reducing the possibility of mechanical damage to, the concealed portion(s) of the component(s).

The portable grill 100 of FIGS. 1-11 further includes an example table 118 rigidly coupled to the frame 108. The table 118 is configured to support and/or carry one or more item(s) including, for example, one or more food item(s), one or more food preparation item(s), one or more cooking utensil(s), and/or one or more food temperature monitoring device(s). In the illustrated example of FIGS. 1-11, the table 118 extends between the front rail 110 and the rear rail 112 of the frame 108, and further extends from the right side rail 114 of the frame 108 to and/or toward the right side of the cookbox 104, thereby substantially filling a gap that would otherwise exist between the right side rail 114 of the frame 108 and the right side of the cookbox 104 as a result of the cookbox 104 being asymmetrically located and/or positioned toward the left side rail 116 of the frame 108. In other examples described above in which the cookbox 104 is instead asymmetrically located and/or positioned toward the right side rail 114 of the frame 108, the table 118 can instead be located and/or positioned between the left side rail 116 of the frame 108 and the left side of the cookbox 104. In still other examples described above in which the cookbox 104 is instead centrally located and/or positioned relative to the right side rail 114 and the left side rail 116 of the frame 108, a second table (e.g., configured as a mirror image of the table 118) can be located and/or positioned between the left side rail 116 of the frame 108 and the left side of the cookbox 104.

The portable grill 100 of FIGS. 1-11 further includes an example support member 202 (e.g., a support plate) rigidly coupled to the frame 108, with the support member 202 being located and/or positioned below (e.g., along an underside of) the table 118. The support member 202 is configured to support and/or carry one or more portion(s) of one or more component(s) of the portable grill 100. For example, the support member 202 can support and/or carry one or more portion(s) of one or more component(s) of any of the table 118, a valve and regulator assembly, a leg lock assembly, and/or a tank blocker of the portable grill 100, as further described below. In the illustrated example of FIGS. 1-11, the support member 202 extends between and is rigidly coupled to the front rail 110 and the rear rail 112 of the frame 108.

The portable grill 100 of FIGS. 1-11 further includes an example valve and regulator assembly 204 located and/or positioned below the support member 202 and/or the table 118, and coupled to the support member 202 and/or the frame 108. The valve and regulator assembly 204 includes a tank connector, a burner tube connector, and a valve stem. The tank connector is configured to removably couple (e.g., via a threaded connection) a fuel tank to the valve and regulator assembly 204 and/or, more generally, to the portable grill 100. The burner tube connector is configured to couple the valve and regulator assembly 204 to a burner tube of the portable grill 100 such that gaseous fuel received at the valve and regulator assembly 204 from a connected fuel tank is directed into the burner tube. The valve stem is configured to control and/or regulate the flow of gaseous fuel through the valve and regulator assembly 204 and/or into the burner tube. For example, movement (e.g., rotation) of the valve stem in a first direction may increase the flow of gaseous fuel through the valve and regulator assembly 204 and/or into the burner tube, while movement (e.g., rotation) of the valve stem in a second direction opposite the first direction may decrease the flow of gaseous fuel through the valve and regulator assembly 204 and/or into the burner tube.

An example control knob 120 is rigidly coupled to the valve stem of the valve and regulator assembly 204 such that the control knob 120 and the valve stem move (e.g., rotate) in a unitary manner. The control knob 120 is configured to be moved (e.g., rotated) by a user of the portable grill 100 to control and/or regulate (e.g., via the valve stem coupled to the control knob 120) the flow of gaseous fuel through the valve and regulator assembly 204 and/or into the burner tube. In the illustrated example of FIGS. 1-11, the valve stem of the valve and regulator assembly 204 extends through an opening (e.g., a through hole) formed in the front rail 110 of the frame 108. The control knob 120 is coupled to a free end of the valve stem, and is located and/or positioned along the front rail 110 of the frame 108 (e.g., along a front surface of the front rail 110).

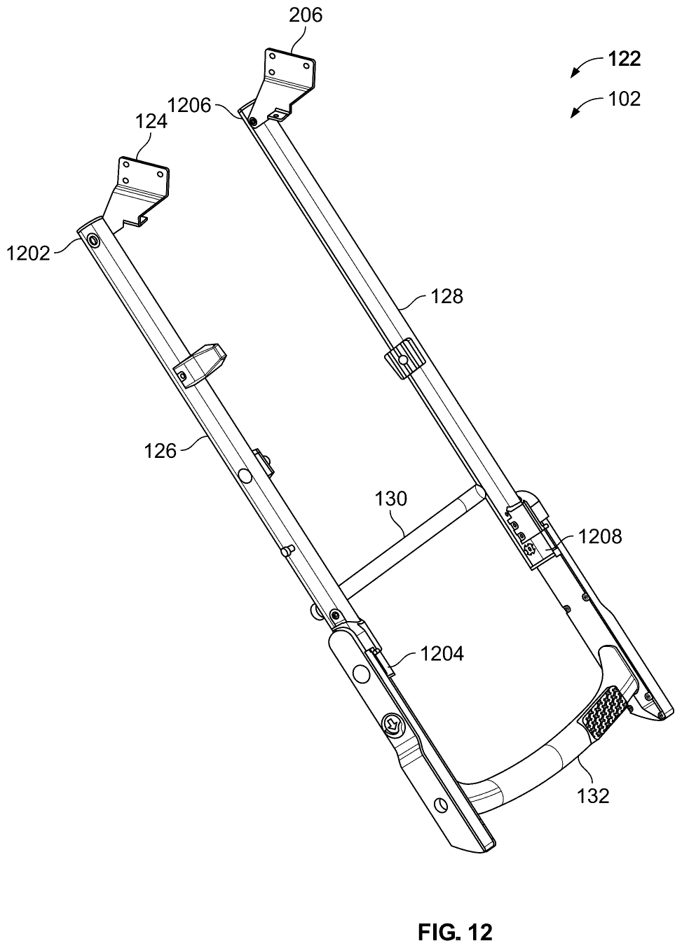

The portable grill 100 of FIGS. 1-11 further includes an example first leg unit 122 coupled to the frame 108. In the illustrated example of FIGS. 1-11, the first leg unit 122 includes an example front flange 124, an example rear flange 206, an example front leg 126, an example rear leg 128, an example crossbar 130, and an example foldable foot 132. FIG. 12 provides a perspective view of the first leg unit 122 of the portable grill 100 of FIGS. 1-11 shown in isolation, with the first leg unit 122 shown in the erected configuration 102 of FIGS. 1-8. The front flange 124 and the rear flange 206 of the first leg unit 122 are rigidly coupled to the frame 108. More specifically, the front flange 124 of the first leg unit 122 is rigidly coupled (e.g., via one or more fastener(s)) to the front rail 110 of the frame 108, and the rear flange 206 of the first leg unit 122 is rigidly coupled (e.g., via one or more fastener(s)) to the rear rail 112 of the frame 108.

The front leg 126 of the first leg unit 122 of FIGS. 1-12 includes an example first end 1202 and an example second end 1204 located opposite the first end 1202. The first end 1202 of the front leg 126 of the first leg unit 122 is pivotally coupled (e.g., via one or more fastener(s)) to the front flange 124 of the first leg unit 122 such that the front leg 126 of the first leg unit 122 is rotatable relative to the front flange 124 of the first leg unit 122, and/or relative to the frame 108. The rear leg 128 of the first leg unit 122 of FIGS. 1-12 similarly includes an example first end 1206 and an example second end 1208 located opposite the first end 1206. The first end 1206 of the rear leg 128 of the first leg unit 122 is pivotally coupled (e.g., via one or more fastener(s)) to the rear flange 206 of the first leg unit 122 such that the rear leg 128 of the first leg unit 122 is rotatable relative to the rear flange 206 of the first leg unit 122, and/or relative to the frame 108. The rear leg 128 of the first leg unit 122 of FIGS. 1-12 is spaced apart from the front leg 126 of the first leg unit 122 of FIGS. 1-12. In the illustrated example of FIGS. 1-12 the rear leg 128 of the first leg unit 122 is parallel to the front leg 126 of the first leg unit 122.

The crossbar 130 of the first leg unit 122 of FIGS. 1-12 extends between and is rigidly coupled to the front leg 126 and the rear leg 128 of the first leg unit 122 such that movement (e.g., rotation) of the front leg 126 of the first leg unit 122 occurs in a unitary manner relative to movement (e.g., rotation) of the rear leg 128 of the first leg unit 122, and vice-versa. In the illustrated example of FIGS. 1-12, the crossbar 130 of the first leg unit 122 is rigidly coupled to the front leg 126 of the first leg unit 122 at a location between the first end 1202 and the second end 1204 of the front leg 126, and is further rigidly coupled to the rear leg 128 of the first leg unit 122 at a location between the first end 1206 and the second end 1208 of the rear leg 128. In some examples, the crossbar 130 of the first leg unit 122 is rigidly coupled to the front leg 126 and the rear leg 128 of the first leg unit 122 via one or more fastener(s). In other examples, the crossbar 130 of the first leg unit 122 can instead be integrally formed with the front leg 126 and the rear leg 128 of the first leg unit 122.

The foldable foot 132 of the first leg unit 122 of FIGS. 1-12 is pivotally coupled (e.g., via one or more fastener(s)) to the second end 1204 of the front leg 126 of the first leg unit 122 and to the second end 1208 of the rear leg 128 of the first leg unit 122 such that the foldable foot 132 is rotatable relative to the front leg 126 and the rear leg 128 between an unfolded position (e.g., as shown in FIGS. 1-11) and a folded position. When the foldable foot 132 is in the unfolded position, the foldable foot 132 is generally aligned with (e.g., extending in a same direction as) the front leg 126 and the rear leg 128 of the first leg unit 122. When the foldable foot 132 is in the folded position, the foldable foot 132 is oriented at an angle (e.g., a substantially orthogonal angle) relative to the front leg 126 and the rear leg 128 of the first leg unit 122. In some examples, the portable grill 100 has a first width when the foldable foot 132 is the unfolded position and the portable grill 100 is in the collapsed configuration 902, and further has a second width less than the first width when the foldable foot 132 is in the folded configuration and the portable grill 100 is the collapsed configuration 902. Accordingly, movement of the foldable foot 132 from the unfolded position into the folded position can advantageously reduce the width of the portable grill 100, which can be advantageous when a user wishes to transport the portable grill 100 in a confined space (e.g., e.g., a trunk, a flatbed, or a cargo area of a vehicle).

The foldable foot 132 of the first leg unit 122 of FIGS. 1-12 is configured to engage and/or contact the underlying surface 302 in connection with supporting the portable grill 100 when the foldable foot 132 is in the unfolded position, and the portable grill 100 is positioned in the erected configuration 102 and oriented horizontally (e.g., parallel) to the underlying surface 302 (e.g., as shown in FIGS. 3-6). The foldable foot 132 is further configured to provide and/or function as a handle by which the portable grill 100 can be pushed and/or pulled when the foldable foot 132 is in the unfolded position, and the portable grill 100 is positioned in the collapsed configuration 902 and oriented either vertically (e.g., perpendicular) relative to the underlying surface 302 or at an angle (e.g., a forty-five degree angle) relative the underlying surface 302. The foldable foot 132 is further configured to provide and/or function as a handle by which the portable grill 100 can be picked up and/or carried when the foldable foot 132 is in the folded position, and the portable grill 100 is positioned in the collapsed configuration 902 and oriented horizontally (e.g., parallel) relative to the underlying surface 302.

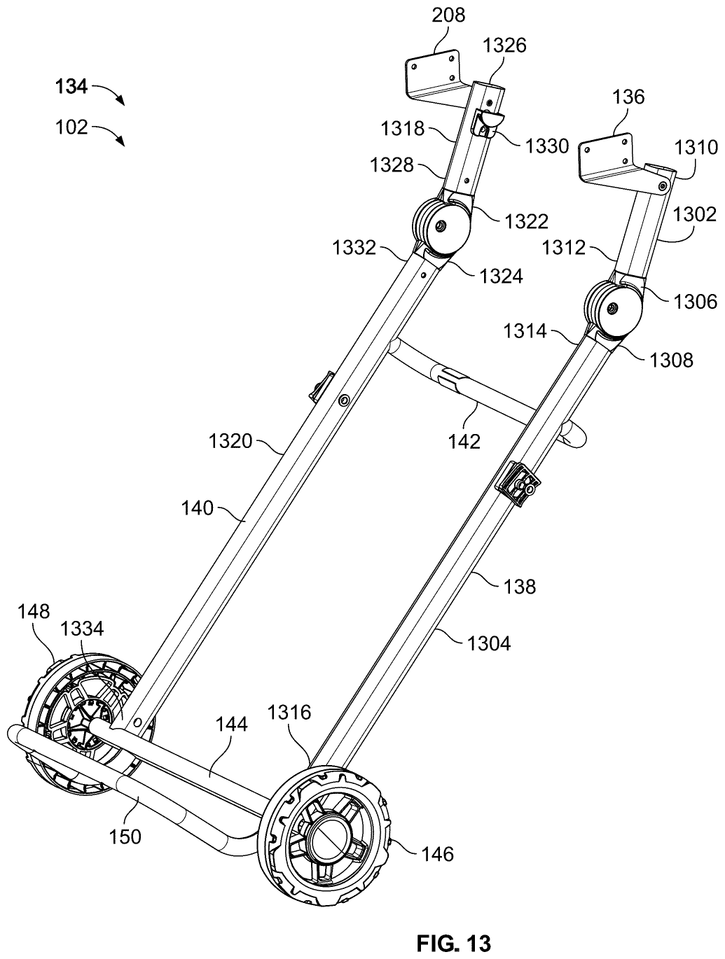

The portable grill 100 of FIGS. 1-11 further includes an example second leg unit 134 coupled to the frame 108. In the illustrated example of FIGS. 1-11, the second leg unit 134 includes an example front flange 136, an example rear flange 208, an example front leg 138, an example rear leg 140, an example first support bar 142, an example wheel support frame 144, an example first wheel 146, an example second wheel 148, and an example second support bar 150. FIG. 13 provides a perspective view of the second leg unit 134 of the portable grill 100 of FIGS. 1-11 shown in isolation, with the second leg unit 134 shown in the erected configuration 102 of FIGS. 1-8. The front flange 136 and the rear flange 208 of the second leg unit 134 are rigidly coupled to the frame 108. More specifically, the front flange 136 of the second leg unit 134 is rigidly coupled (e.g., via one or more fastener(s)) to the front rail 110 of the frame 108, and the rear flange 208 of the second leg unit 134 is rigidly coupled (e.g., via one or more fastener(s)) to the rear rail 112 of the frame 108.

The front leg 138 of the second leg unit 134 of FIGS. 1-11 and 13 includes an example first segment 1302 (e.g., an upper segment), an example second segment 1304 (e.g., a lower segment), an example first hinge member 1306 (e.g., an upper hinge member), and an example second hinge member 1308 (e.g., a lower hinge member). The first segment 1302 of the front leg 138 includes an example first end 1310 and an example second end 1312 located opposite the first end 1310. The second segment 1304 of the front leg 138 includes an example first end 1314 and an example second end 1316 located opposite the first end 1314. The first end 1310 of the first segment 1302 of the front leg 138 is pivotally coupled (e.g., via one or more fastener(s)) to the front flange 136 of the second leg unit 134 such that the first segment 1302 of the front leg 138 of the second leg unit 134 is rotatable relative to the front flange 136 of the second leg unit 134, and/or relative to the frame 108. The second end 1312 of the first segment 1302 of the front leg 138 is rigidly coupled (e.g., via one or more fastener(s)) to the first hinge member 1306 of the front leg 138. The first end 1314 of the second segment 1304 of the front leg 138 is rigidly coupled (e.g., via one or more fastener(s)) to the second hinge member 1308 of the front leg 138. The second end 1316 of the second segment 1304 of the front leg 138 is rigidly coupled (e.g., via one or more fastener(s)) to the wheel support frame 144 of the second leg unit 134.

The front leg 138 of the second leg unit 134 of FIGS. 1-11 and 13 includes an example hinge 1317 formed by the first hinge member 1306 and the second hinge member 1308 of the front leg 138. More specifically, the second hinge member 1308 of the front leg 138 is pivotally coupled (e.g., via one or more fastener(s)) to the first hinge member 1306 of the front leg 138 (e.g., thereby forming the hinge 1317 of the front leg 138) such that the second hinge member 1308 of the front leg 138 of the second leg unit 134 is rotatable relative to the first hinge member 1306 of the front leg 138 of the second leg unit 134, and/or such that the second segment 1304 of the front leg 138 of the second leg unit 134 is rotatable relative to the first segment 1302 of the front leg 138 of the second leg unit 134. The front leg 138 of the second leg unit 134 is accordingly a hinged leg having a hinge axis (e.g., an axis of rotation of the hinge 1317) located between the first hinge member 1306 and the second hinge member 1308 of the front leg 138, and/or between the first segment 1302 and the second segment 1304 of the front leg 138.

Like the front leg 138 described above, the rear leg 140 of the second leg unit 134 of FIGS. 1-11 and 13 similarly includes an example first segment 1318 (e.g., an upper segment), an example second segment 1320 (e.g., a lower segment), an example first hinge member 1322 (e.g., an upper hinge member), and an example second hinge member 1324 (e.g., a second hinge member). The first segment 1318 of the rear leg 140 includes an example first end 1326 and an example second end 1328 located opposite the first end 1326. As shown in FIG. 13, the second leg unit 134 further includes an example carriage 1330 that is movably coupled (e.g., slidably coupled within a slot) to the first segment 1318 of the rear leg 140 between the first end 1326 and the second end 1328 of the first segment 1318. The carriage 1330 is part of a leg lock assembly of the portable grill 100, as further described herein. The second segment 1320 of the rear leg 140 includes an example first end 1332 and an example second end 1334 located opposite the first end 1332. The first end 1326 of the first segment 1318 of the rear leg 140 is pivotally coupled (e.g., via one or more fastener(s)) to the rear flange 208 of the second leg unit 134 such that the first segment 1318 of the rear leg 140 of the second leg unit 134 is rotatable relative to the rear flange 208 of the second leg unit 134, and/or relative to the frame 108. The second end 1328 of the first segment 1318 of the rear leg 140 is rigidly coupled (e.g., via one or more fastener(s)) to the first hinge member 1322 of the rear leg 140. The first end 1332 of the second segment 1320 of the rear leg 140 is rigidly coupled (e.g., via one or more fastener(s)) to the second hinge member 1324 of the rear leg 140. The second end 1334 of the second segment 1320 of the rear leg 140 is rigidly coupled (e.g., via one or more fastener(s)) to the wheel support frame 144 of the second leg unit 134.

The rear leg 140 of the second leg unit 134 of FIGS. 1-11 and 13 includes an example hinge 1335 formed by the first hinge member 1322 and the second hinge member 1324 of the rear leg 140. More specifically, the second hinge member 1324 of the rear leg 140 is pivotally coupled (e.g., via one or more fastener(s)) to the first hinge member 1322 of the rear leg 140 (e.g., thereby forming the hinge 1335 of the rear leg 140) such that the second hinge member 1324 of the rear leg 140 of the second leg unit 134 is rotatable relative to the first hinge member 1322 of the rear leg 140 of the second leg unit 134, and/or such that the second segment 1320 of the rear leg 140 of the second leg unit 134 is rotatable relative to the first segment 1318 of the rear leg 140 of the second leg unit 134. The rear leg 140 of the second leg unit 134 is accordingly a hinged leg having a hinge axis (e.g., an axis of rotation of the hinge 1335) located between the first hinge member 1322 and the second hinge member 1324 of the rear leg 140, and/or between the first segment 1318 and the second segment 1320 of the rear leg 140. In the illustrated example of FIGS. 1-11 and 13, the hinge axis of the rear leg 140 of the second leg unit 134 is coaxially aligned with the hinge axis of the front leg 138 of the second leg unit 134. The rear leg 140 of the second leg unit 134 of FIGS. 1-11 and 13 is spaced apart from the front leg 138 of the second leg unit 134 of FIGS. 1-11 and 13. In the illustrated example of FIGS. 1-11 and 13 the rear leg 140 of the second leg unit 134 is parallel to the front leg 138 of the second leg unit 134, with the first segment 1318 and the second segment 1320 of the rear leg 140 respectively being parallel to corresponding ones of the first segment 1302 and the second segment 1304 of the front leg 138.

The first support bar 142 of the second leg unit 134 of FIGS. 1-11 and 13 extends between and is rigidly coupled to the front leg 138 and the rear leg 140 of the second leg unit 134 such that movement (e.g., rotation and/or translation) of the front leg 138 of the second leg unit 134 occurs in a unitary manner relative to movement (e.g., rotation and/or translation) of the rear leg 140 of the second leg unit 134, and vice-versa. In the illustrated example of FIGS. 1-11 and 13, the first support bar 142 of the second leg unit 134 is rigidly coupled to the front leg 138 of the second leg unit 134 at a location between the first end 1314 and the second end 1316 of the second segment 1304 of the front leg 138, and is further rigidly coupled to the rear leg 140 of the second leg unit 134 at a location between the first end 1332 and the second end 1334 of the second segment 1320 of the rear leg 140. In some examples, the first support bar 142 of the second leg unit 134 is rigidly coupled to the front leg 138 and the rear leg 140 of the second leg unit 134 via one or more fastener(s). In other examples, the first support bar 142 of the second leg unit 134 can instead be integrally formed with the front leg 138 and the rear leg 140 of the second leg unit 134.

In the illustrated example of FIGS. 1-11 and 13, the first support bar 142 of the second leg unit 134 extends at an angle (e.g., orthogonally) away from the front leg 138 and the rear leg 140 of the second leg unit 134. The first support bar 142 of the second leg unit 134 is configured to maintain the cookbox 104 and/or one or more other component(s) (e.g., the valve and regulator assembly 204, a leg lock assembly, a tank blocker, etc.) of the portable grill 100 at a separated distance above and/or apart from the underlying surface 302 when the portable grill 100 is positioned in the collapsed configuration 902 and oriented horizontally (e.g., parallel) relative to the underlying surface 302 (e.g., as shown in FIG. 11), thereby advantageously reducing wear on, and/or reducing the possibility of mechanical damage to, the cookbox 104 and/or the other component(s) of the portable grill 100. The first support bar 142 of the second leg unit 134 is further configured to provide and/or function as a structure by which the portable grill 100 can be hung (e.g., from a hanging mechanism, such as one or more hook(s)) when the portable grill 100 is positioned in the collapsed configuration 902 and oriented vertically (e.g., perpendicular) relative to the underlying surface 302.

The wheel support frame 144 of the second leg unit 134 of FIGS. 1-11 and 13 extends between and is rigidly coupled to the front leg 138 and the rear leg 140 of the second leg unit 134 such that movement (e.g., rotation and/or translation) of the front leg 138 of the second leg unit 134 occurs in a unitary manner relative to movement (e.g., rotation and/or translation) of the rear leg 140 of the second leg unit 134, and vice-versa. In the illustrated example of FIGS. 1-11 and 13, the wheel support frame 144 of the second leg unit 134 is rigidly coupled to the second end 1316 of the second segment 1304 of the front leg 138 of the second leg unit 134, and is further rigidly coupled to the second end 1334 of the second segment 1320 of the rear leg 140 of the second leg unit 134. The wheel support frame 144 includes a wheel axis that extends through an opening formed in the wheel support frame 144. The first wheel 146 and the second wheel 148 of the second leg unit 134 are respectively coupled to the wheel axis (e.g., at opposite ends of the wheel axis), and are rotatable relative to the wheel support frame 144 of the second leg unit 134. The first wheel 146 and the second wheel 148 are respectively configured to enable the portable grill 100 to be moved (e.g., pushed or pulled) along the underlying surface 302 when the first wheel 146 and the second wheel 148 are in contact with the underlying surface 302.

The second support bar 150 of the second leg unit 134 of FIGS. 1-11 and 13 extends from and is rigidly coupled to the wheel support frame 144 of the second leg unit 134 such that movement of the second support bar 150 occurs in a unitary manner relative to movement of the wheel support frame 144. In some examples, the second support bar 150 of the second leg unit 134 is rigidly coupled to the wheel support frame 144 of the second leg unit 134 via one or more fastener(s). In other examples, the second support bar 150 of the second leg unit 134 can instead be integrally formed with the wheel support frame 144. In still other examples, the ends of the second support bar 150 of the second leg unit 134 can extend through the wheel support frame 144, and can respectively be coupled (e.g., via one or more fastener(s)) to the front leg 138 and the rear leg 140 of the second leg unit 134 (e.g., at the second end 1316 of the second segment 1304 of the front leg 138, and the second end 1334 of the second segment 1320 of the rear leg 140).

In the illustrated example of FIGS. 1-11 and 13, the second support bar 150 of the second leg unit 134 extends at an angle (e.g., orthogonally) away from the front leg 138 and the rear leg 140 of the second leg unit 134. The second support bar 150 of the second leg unit 134 is configured to engage and/or contact the underlying surface 302 when the portable grill 100 is positioned in the collapsed configuration 902 and oriented vertically (e.g., perpendicular) relative to the underlying surface 302, thereby advantageously providing and/or functioning as a mechanical support to maintain the portable grill 100 in a vertical orientation relative to the underlying surface 302. The second support bar 150 of the second leg unit 134 is further configured to provide and/or function as a handle by which the portable grill 100 can be picked up and/or carried when the portable grill 100 is positioned in the collapsed configuration 902 and oriented horizontally (e.g., parallel) relative to the underlying surface 302 (e.g., as shown in FIG. 11).

In the illustrated example of FIGS. 1-11, the first leg unit 122 and the second leg unit 134 described above are pivotally coupled to one another. For example, the front leg 126 of the first leg unit 122 is pivotally coupled (e.g., via one or more fastener(s)) to the second segment 1304 of the front leg 138 of the second leg unit 134 at a location (e.g., a first pivot axis) between the first end 1202 and the second end 1204 of the front leg 126 of the first leg unit 122, and further between the first end 1314 and the second end 1316 of the second segment 1304 of the front leg 138 of the second leg unit 134. Similarly, the rear leg 128 of the first leg unit 122 is pivotally coupled (e.g., via one or more fastener(s)) to the second segment 1320 of the rear leg 140 of the second leg unit 134 at a location (e.g., a second pivot axis) between the first end 1206 and the second end 1208 of the rear leg 128 of the first leg unit 122, and further between the first end 1332 and the second end 1334 of the second segment 1320 of the rear leg 140 of the second leg unit 134. In the illustrated example of FIGS. 1-11, the location at which the front leg 126 of the first leg unit 122 is pivotally coupled to the second segment 1304 of the front leg 138 of the second leg unit 134 defines a first pivot axis, and the location at which the rear leg 128 of the first leg unit 122 is pivotally coupled to the second segment 1320 of the rear leg 140 of the second leg unit 134 defines a second pivot axis. In the illustrated example of FIGS. 1-11, the second pivot axis associated with the rear leg 128 of the first leg unit 122 and the rear leg 140 of the second leg unit 134 is coaxially aligned with the first pivot axis associated with the front leg 126 of the first leg unit 122 and the front leg 138 of the second leg unit 134.

The first leg unit 122 and the second leg unit 134 of the portable grill 100 collectively provide a collapsible and/or foldable base configured to support the cookbox 104 and/or the frame 108 of the portable grill 100, and further configured to enable the portable grill 100 to be transitioned from the erected configuration 102 shown in FIGS. 1-8 into the collapsed configuration 902 shown in FIGS. 9-11, and vice-versa. When the portable grill 100 is positioned in the erected configuration 102 shown in FIGS. 1-8, the front leg 126 and the rear leg 128 of the first leg unit 122 are oriented at an angle (e.g., a ninety degree angle) relative to the second segment 1304 of the front leg 138 and the second segment 1320 of the rear leg 140 of the second leg unit 134. The arrangement of the front leg 126 and the rear leg 128 of the first leg unit 122 and the front leg 138 and the rear leg 140 of the second leg unit 134 associated with the erected configuration 102 of the portable grill 100 causes the frame 108 of the portable grill 100 to be positioned at a first height above the underlying surface 302 (e.g., as shown in FIG. 3). When the portable grill 100 is positioned in the collapsed configuration 902 shown in FIGS. 9-11, the front leg 126 and the rear leg 128 of the first leg unit 122 are generally parallel relative to at least the second segment 1304 of the front leg 138 and at least the second segment 1320 of the rear leg 140 of the second leg unit 134. The arrangement of the front leg 126 and the rear leg 128 of the first leg unit 122 and the front leg 138 and the rear leg 140 of the second leg unit 134 associated with the collapsed configuration 902 of the portable grill 100 causes the frame 108 of the portable grill 100 to be positioned at a second height above the underlying surface 302 (e.g., as shown in FIG. 11), with the second height being considerably less than the first height associated with the erected configuration 102 of the portable grill 100.

The portable grill 100 of FIGS. 1-11 further includes an example leg lock assembly 210 configured to lock the position of the front leg 138 and/or the rear leg 140 of the second leg unit 134 of the portable grill 100 relative to the frame 108 of the portable grill 100, which in turn also locks the position of the front leg 126 and/or the rear leg 128 of the first leg unit 122 of the portable grill 100 relative to the frame 108 of the portable grill 100. The leg lock assembly 210 is configured to lock the position of the front leg 138 and/or the rear leg 140 of the second leg unit 134 relative to the frame 108 when the portable grill 100 is positioned in the erected configuration 102 shown in FIGS. 1-8 (e.g., while the portable grill 100 is being used to cook).

In some examples, one or more portion(s) of one or more component(s) of the leg lock assembly 210 is/are located and/or positioned within one or more rail(s) of the frame 108 (e.g., the front rail 110, the rear rail 112, the right side rail 114, and/or the left side rail 116), and/or within one or more segment(s) or member(s) of the leg(s) of the second leg unit 134 (e.g., the first segment 1302, the second segment 1304, the first hinge member 1306, and/or the second hinge member 1308 of the front leg 138, and/or the first segment 1318, the second segment 1320, the first hinge member 1322, and/or the second hinge member 1324 of the rear leg 140) of the portable grill 100 such that said portion(s) of said component(s) of the leg lock assembly 210 is/are partially or fully concealed from exposure, thereby advantageously reducing wear on, and/or reducing the possibility of mechanical damage to, the concealed portion(s) of the component(s) of the leg lock assembly 210. In some examples, one or more portion(s) of one or more component(s) of the leg lock assembly 210 is/are located and/or positioned below (e.g., along an underside of) the table 118 of the portable grill 100 such that said portion(s) of said component(s) of the leg lock assembly 210 is/are partially or fully concealed from exposure, thereby advantageously reducing wear on, and/or reducing the possibility of mechanical damage to, the concealed portion(s) of the component(s) of the leg lock assembly 210.

The leg lock assembly 210 of the portable grill 100 of FIGS. 1-11 includes an example handle 212 configured to unlock and/or release the locked position(s) of the front leg 138 and/or the rear leg 140 of the second leg unit 134 relative to the frame 108 of the portable grill 100 in response to actuation (e.g., translation and/or rotation) of the handle 212 by a user of the portable grill 100. The handle 212 is actuatable to unlock and/or release the locked position(s) of the front leg 138 and/or the rear leg 140 of the second leg unit 134 relative to the frame 108 when the portable grill 100 is positioned in the erected configuration 102 shown in FIGS. 1-8. Actuation of the handle 212 facilitates transitioning the portable grill 100 from the erected configuration 102 into the collapsed configuration 902. In some examples, the handle 212 of the leg lock assembly 210 is configured to be actuated using only one hand of the user of the portable grill 100, thereby advantageously leaving the other hand of the user free to assist with tasks aside from actuating the handle 212.

In the illustrated example of FIGS. 1-11, a first portion of the leg lock assembly 210 is coupled to the rear rail 112 of the frame 108, and a second portion of the leg lock assembly 210 is coupled to the rear leg 140 of the second leg unit 134. In other examples, the leg lock assembly 210 of the portable grill 100 can instead be implemented such that a first portion of the leg lock assembly 210 is coupled to the front rail 110 of the frame 108, and a second portion of the leg lock assembly 210 is coupled to the front leg 138 of the second leg unit 134. In still other examples, the portable grill 100 can be configured to include two separate instances of the leg lock assembly 210, with the first instance of the leg lock assembly 210 including a first portion coupled to the front rail 110 of the frame 108 and a second portion coupled to the front leg 138 of the second leg unit 134, and with the second instance of the leg lock assembly 210 (e.g., as shown in FIGS. 1-11) including a first portion coupled to the rear rail 112 of the frame 108 and a second portion coupled to the rear leg 140 of the second leg unit 134.

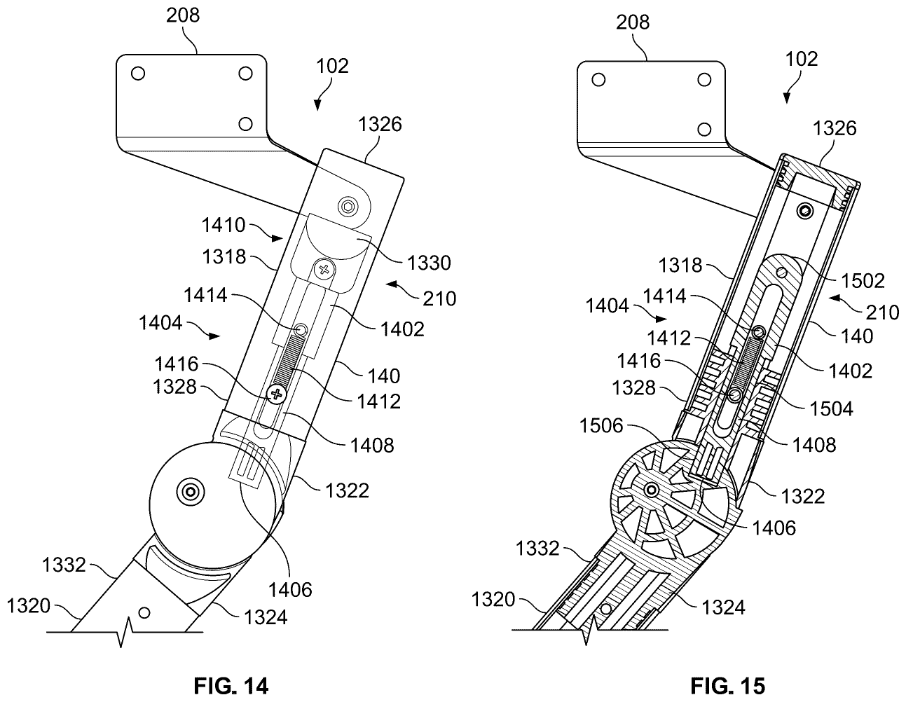

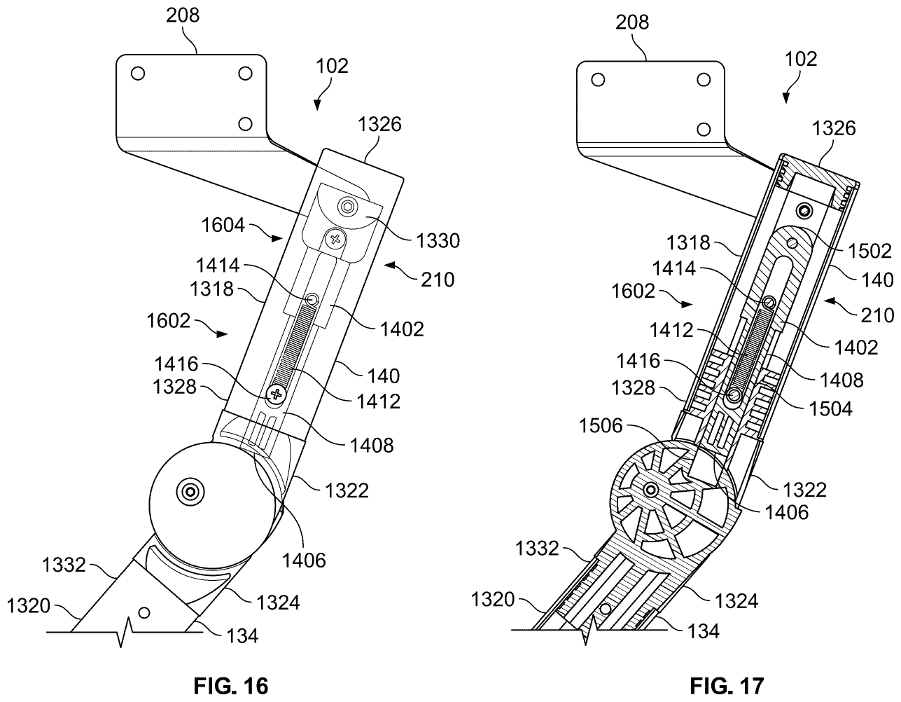

FIGS. 14-17 illustrate a portion of the leg lock assembly 210 that is formed by, carried by, housed within, and/or coupled to the rear leg 140 of the second leg unit 134 of the portable grill 100. Several components of the portion of the leg lock assembly 210 illustrated in FIGS. 14-17 are formed by and/or housed within the first segment 1318, the first hinge member 1322, and/or the second hinge member 1324 of the rear leg 140 of the second leg unit 134, as further described herein. For example, as shown in FIGS. 14-17, the illustrated portion of the leg lock assembly 210 includes an example plunger 1402 that is housed and/or located within the first segment 1318, the first hinge member 1322, and/or the second hinge member 1324 of the rear leg 140 of the second leg unit 134. The plunger 1402 of the leg lock assembly 210 is movable (e.g., slidable within a slot) relative to the first segment 1318 of the rear leg 140 of the second leg unit 134 between an example locked position 1404 (e.g., as shown in FIGS. 14 and 15) that prevents the portable grill 100 from being transitioned from the erected configuration 102 shown in FIGS. 1-8 into the collapsed configuration 902 shown in FIGS. 9-11, and an example unlocked position 1602 (e.g., as shown in FIGS. 16 and 17) that enables the portable grill 100 to be transitioned from the erected configuration 102 shown in FIGS. 1-8 into the collapsed configuration 902 shown in FIGS. 9-11.

FIG. 14 is a front view of a portion of the rear leg 140 of the second leg unit 134 of FIGS. 1-11 and 13, with the rear leg 140 of the second leg unit 134 shown in the erected configuration 102 of FIGS. 1-8 and 13, with the first segment 1318 of the rear leg 140 shown in phantom to enhance the viewability of a portion of the leg lock assembly 210 of the portable grill 100, and with the plunger 1402 of the leg lock assembly 210 shown in the locked position 1404. FIG. 15 is a cross-sectional view of a portion of the rear leg 140 of the second leg unit 134 of FIGS. 1-11, 13 and 14, with the rear leg 140 of the second leg unit 134 shown in the erected configuration 102 of FIGS. 1-8, 13, and 14, and with the plunger 1402 of the leg lock assembly 210 shown in the locked position 1404. FIG. 16 is a front view of a portion of the rear leg 140 of the second leg unit 134 of FIGS. 1-11 and 13-15, with the rear leg 140 of the second leg unit 134 shown in the erected configuration 102 of FIGS. 1-8 and 13-15, with the first segment 1318 of the rear leg 140 shown in phantom to enhance the viewability of a portion of the leg lock assembly 210 of the portable grill 100, and with the plunger 1402 of the leg lock assembly 210 shown in the unlocked position 1602. FIG. 17 is a cross-sectional view of a portion of the rear leg 140 of the second leg unit 134 of FIGS. 1-11 and 13-16, with the rear leg 140 of the second leg unit 134 shown in the erected configuration 102 of FIGS. 1-8 and 13-16, and with the plunger 1402 of the leg lock assembly 210 shown in the unlocked position 1602.

In the illustrated example of FIGS. 14-17, the plunger 1402 of the leg lock assembly 210 includes an example first end 1502, an example second end 1406, and an example shaft 1408. The second end 1406 of the plunger 1402 is located opposite the first end 1502 of the plunger 1402. The shaft 1408 of the plunger 1402 is located between the first end 1502 and the second end 1406 of the plunger 1402. In the illustrated example of FIGS. 14-17, the first end 1502 of the plunger 1402 is rigidly coupled (e.g., via one or more fastener(s)) to the carriage 1330 of the leg lock assembly 210 such that movement of the plunger 1402 occurs in a unitary manner relative to movement of the carriage 1330. The shaft 1408 of the plunger 1402 is positioned and/or located within an example guide channel 1504 formed in, located within, and/or extending through the first hinge member 1322 of the rear leg 140 of the second leg unit 134. The shaft 1408 of the plunger 1402 is slidable within and/or relative to the guide channel 1504 of the first hinge member 1322 of the rear leg 140 as the plunger 1402 moves between the locked position 1404 and the unlocked position 1602, as further described herein.

The second end 1406 of the plunger 1402 is selectively positioned and/or selectively located within an example cavity 1506 formed in and/or located within the second hinge member 1324 of the rear leg 140 of the second leg unit 134. In this regard, the second end 1406 of the plunger 1402 is positioned and/or located within the cavity 1506 of the second hinge member 1324 of the rear leg 140 when the plunger 1402 is in the locked position 1404 (e.g., as shown in FIGS. 14 and 15). Locating and/or positioning the second end 1406 of the plunger 1402 within the cavity 1506 of the second hinge member 1324 of the rear leg 140 locks the second hinge member 1324 of the rear leg 140 relative to the first hinge member 1322 of the rear leg 140 such that the second hinge member 1324 of the rear leg 140 cannot move (e.g., cannot rotate) relative to the first hinge member 1322 of the rear leg 140, and/or such that the second segment 1320 of the rear leg 140 cannot move (e.g., cannot rotate) relative to the first segment 1318 of the rear leg 140. Locating and/or positioning the second end 1406 of the plunger 1402 within the cavity 1506 of the second hinge member 1324 of the rear leg 140 accordingly prevents the portable grill 100 from being transitioned from the erected configuration 102 shown in FIGS. 1-8 into the collapsed configuration 902 shown in FIGS. 9-11.

Conversely, the second end 1406 of the plunger 1402 is not positioned and/or not located within the cavity 1506 of the second hinge member 1324 of the rear leg 140 when the plunger 1402 is in the unlocked position 1602 (e.g., as shown in FIGS. 16 and 17). Removing and/or withdrawing the second end 1406 of the plunger 1402 from within the cavity 1506 of the second hinge member 1324 of the rear leg 140 unlocks the second hinge member 1324 of the rear leg 140 relative to the first hinge member 1322 of the rear leg 140 such that the second hinge member 1324 of the rear leg 140 is movable (e.g., is rotatable) relative to the first hinge member 1322 of the rear leg 140, and/or such that the second segment 1320 of the rear leg 140 is movable (e.g., is rotatable) relative to the first segment 1318 of the rear leg 140. Removing and/or withdrawing the second end 1406 of the plunger 1402 from within the cavity 1506 of the second hinge member 1324 of the rear leg 140 accordingly enables the portable grill 100 to be transitioned from the erected configuration 102 shown in FIGS. 1-8 into the collapsed configuration 902 shown in FIGS. 9-11.

In the illustrated example of FIGS. 14-17, the carriage 1330 of the leg lock assembly 210 is movable (e.g., slidable) relative to the first segment 1318 of the rear leg 140 of the second leg unit 134 between an example lowered carriage position 1410 (e.g., as shown in FIGS. 14 and 15) and an example raised carriage position 1604 (e.g., as shown in FIGS. 16 and 17). When the carriage 1330 of the leg lock assembly 210 is in the lowered carriage position 1410, the plunger 1402 of the leg lock assembly 210 is in the locked position 1404 described above, which prevents the second hinge member 1324 of the rear leg 140 from moving (e.g., rotating) relative to the first hinge member 1322 of the rear leg 140, and/or prevents the second segment 1320 of the rear leg 140 from moving (e.g., rotating) relative to the first segment 1318 of the rear leg 140. When the carriage 1330 of the leg lock assembly 210 is in the raised carriage position 1604, the plunger 1402 of the leg lock assembly 210 is in the unlocked position 1602 described above, which enables the second hinge member 1324 of the rear leg 140 to move (e.g., rotate) relative to the first hinge member 1322 of the rear leg 140, and/or enables the second segment 1320 of the rear leg 140 to move (e.g., rotate) relative to the first segment 1318 of the rear leg 140.

Movement of the carriage 1330 of the leg lock assembly 210 from the lowered carriage position 1410 shown in FIGS. 14 and 15 toward and/or into the raised carriage position 1604 shown in FIGS. 16 and 17 occurs in response to actuation and/or movement of a lever of the leg lock assembly 210 that is operatively coupled to the handle 212 of the leg lock assembly 210, as further described herein. Such movement of the carriage 1330 from the lowered carriage position 1410 toward and/or into the raised carriage position 1604 occurs against a biasing force generated by an example first tension spring 1412 of the leg lock assembly 210. In the illustrated example of FIGS. 14-17, the first tension spring 1412 of the leg lock assembly 210 includes a first end coupled to an example first mount 1414 that is coupled to and/or integrally formed with the plunger 1402 of the leg lock assembly 210, and a second end coupled to an example second mount 1416 that is coupled to and/or integrally formed with the first segment 1318 and/or the first hinge member 1322 of the rear leg 140 of the second leg unit 134. For example, as shown in FIGS. 14-17, the first mount 1414 is implemented as a pin that is integrally formed with the plunger 1402, and the second mount 1416 is implemented as a fastener that extends into and/or through the first segment 1318 and/or the first hinge member 1322 of the rear leg 140 of the second leg unit 134. The first tension spring 1412 biases the plunger 1402 of the leg lock assembly 210 into the locked position 1404 shown in FIGS. 14 and 15 and away from the unlocked position 1602 shown in FIGS. 16 and 17. The plunger 1402 of the leg lock assembly 210 accordingly remains in the locked position 1404 until a lifting force sufficient to overcome the biasing force associated with the first tension spring 1412 is applied to the plunger 1402 via the carriage 1330 of the leg lock assembly 210, with the lifting force being applied (e.g., via a lever of the leg lock assembly 210 to the carriage 1330 of the leg lock assembly 210) in a direction that moves (e.g., lifts) the carriage 1330 away from the lowered carriage position 1410 shown in FIGS. 14 and 15 toward and/or into the raised carriage position 1604 shown in FIGS. 16 and 17.

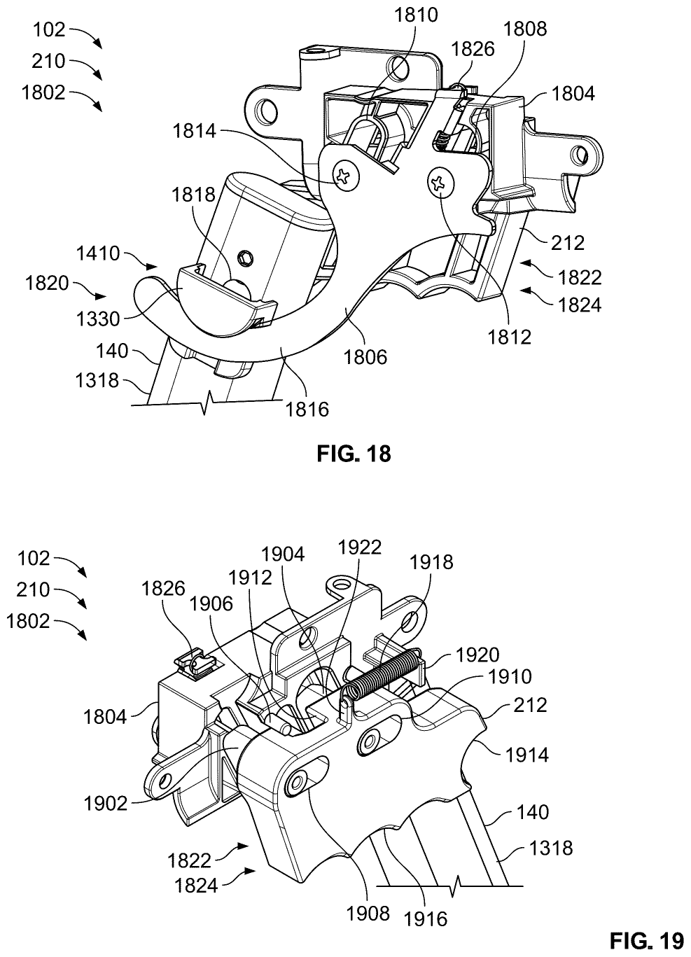

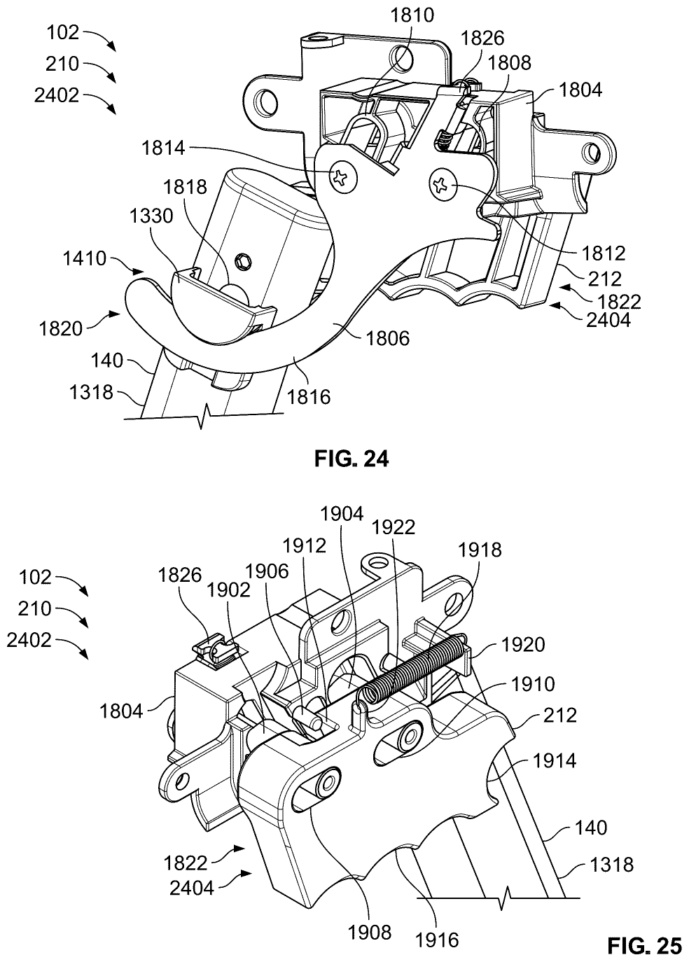

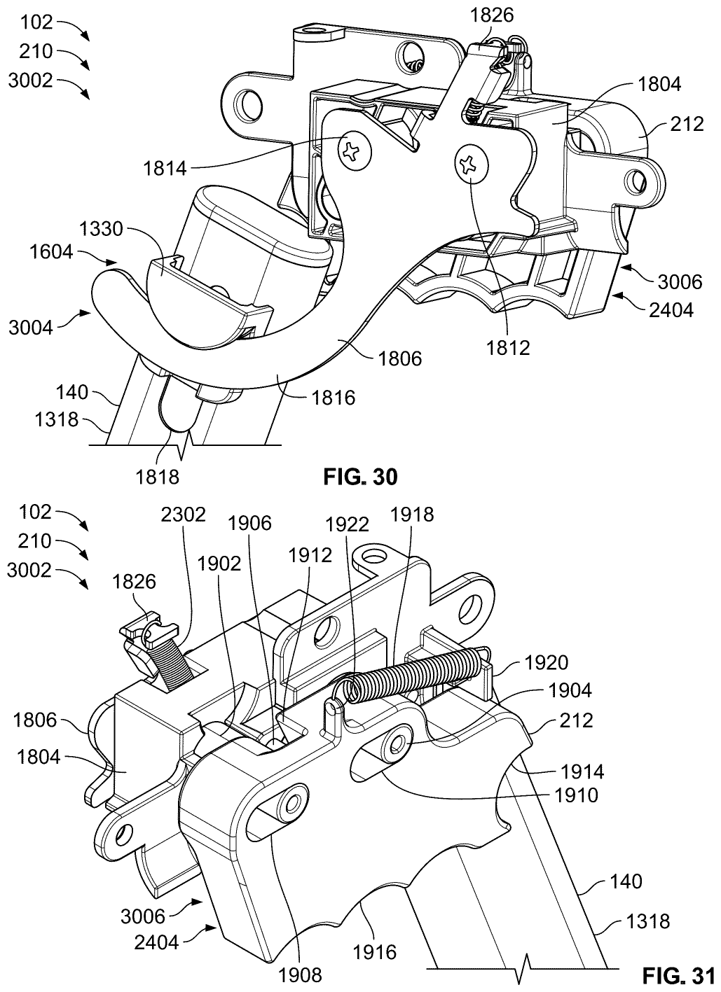

FIGS. 18-41 illustrate a portion of the leg lock assembly 210 that is carried by, housed within, and/or coupled to the rear rail 112 of the frame 108 of the portable grill 100, and which is operatively coupled to the above-described carriage 1330 (and therefore also the above-described plunger 1402) that is carried by, housed within, and/or coupled to the rear leg 140 of the second leg unit 134 of the portable grill 100. Movements of various components of the portion of the illustrated leg lock assembly 210 shown in FIGS. 18-41 enable the leg lock assembly 210 to be transitioned from an example locked configuration 1802 shown in FIGS. 18-23 into an example partially unlocked configuration 2402 shown in FIGS. 24-29, and from the partially unlocked configuration 2402 shown in FIGS. 24-29 into an example unlocked configuration 3002 shown in FIGS. 30-35. Transitioning the leg lock assembly 210 from the locked configuration 1802 into the partially unlocked configuration 2402, and from the partially unlocked configuration 2402 into the unlocked configuration 3002 enables the portable grill 100 to be transitioned from the erected configuration 102 shown in FIGS. 1-8 and 13-35 into the collapsed configuration 902 shown in FIGS. 9-11 and 36-41, as further described herein.

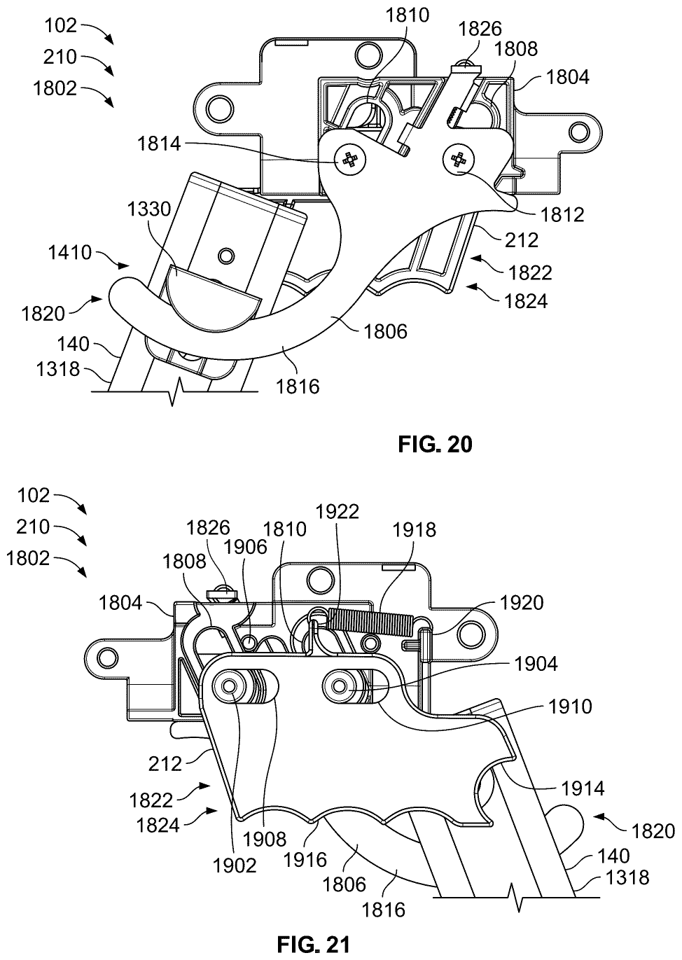

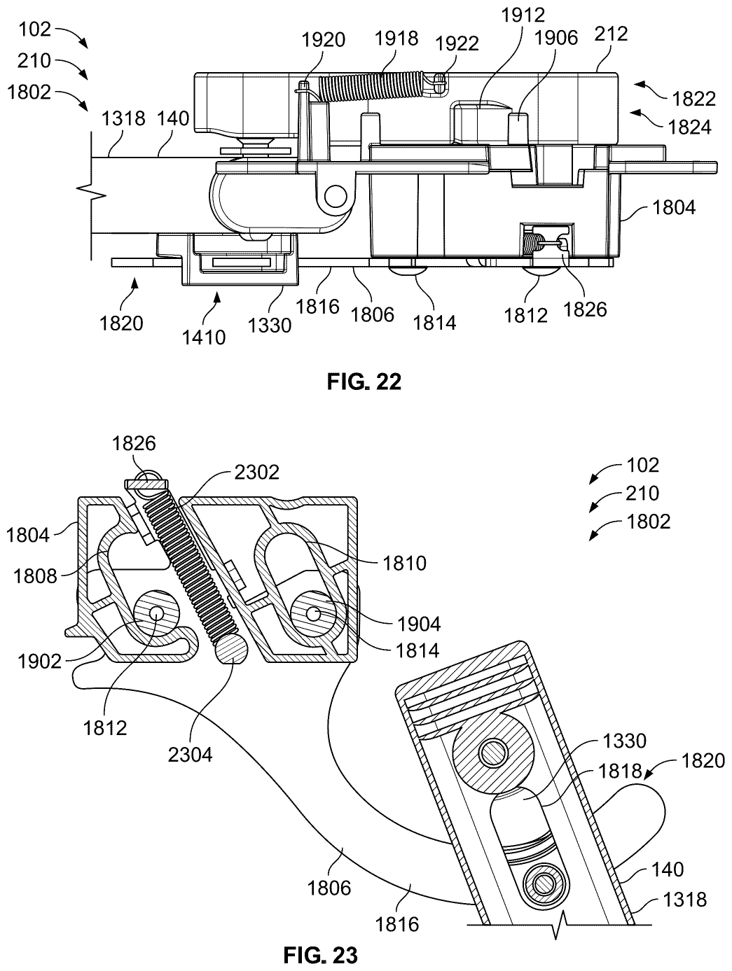

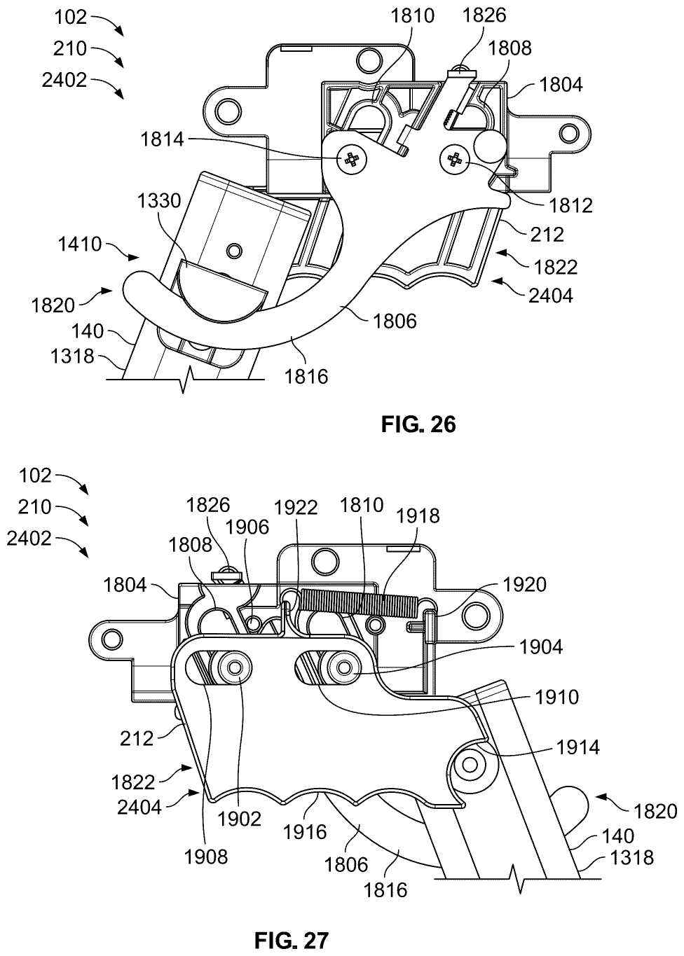

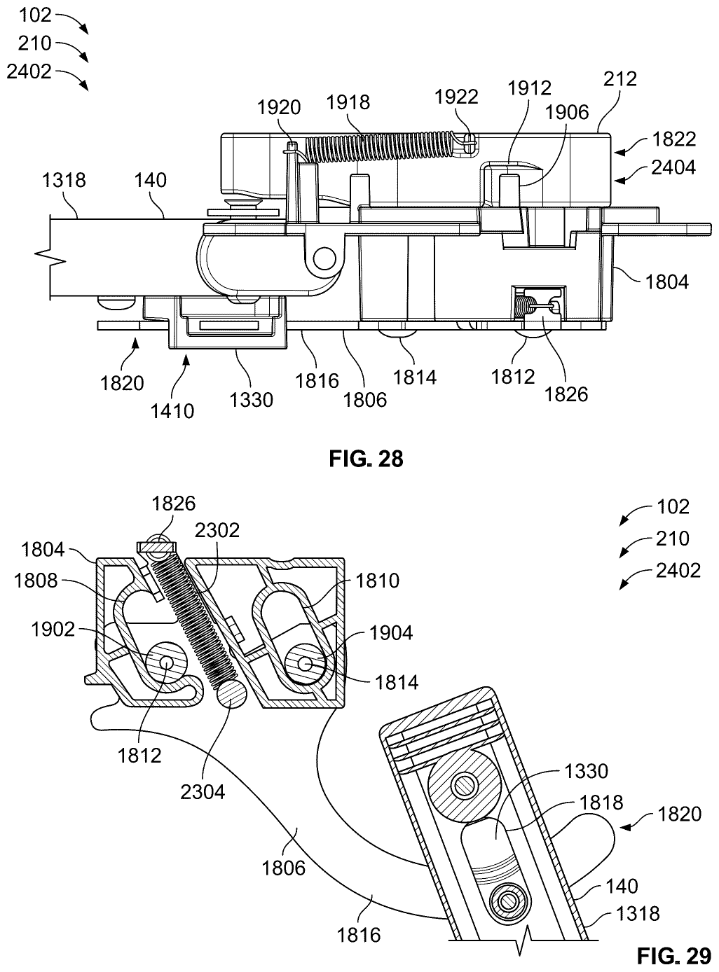

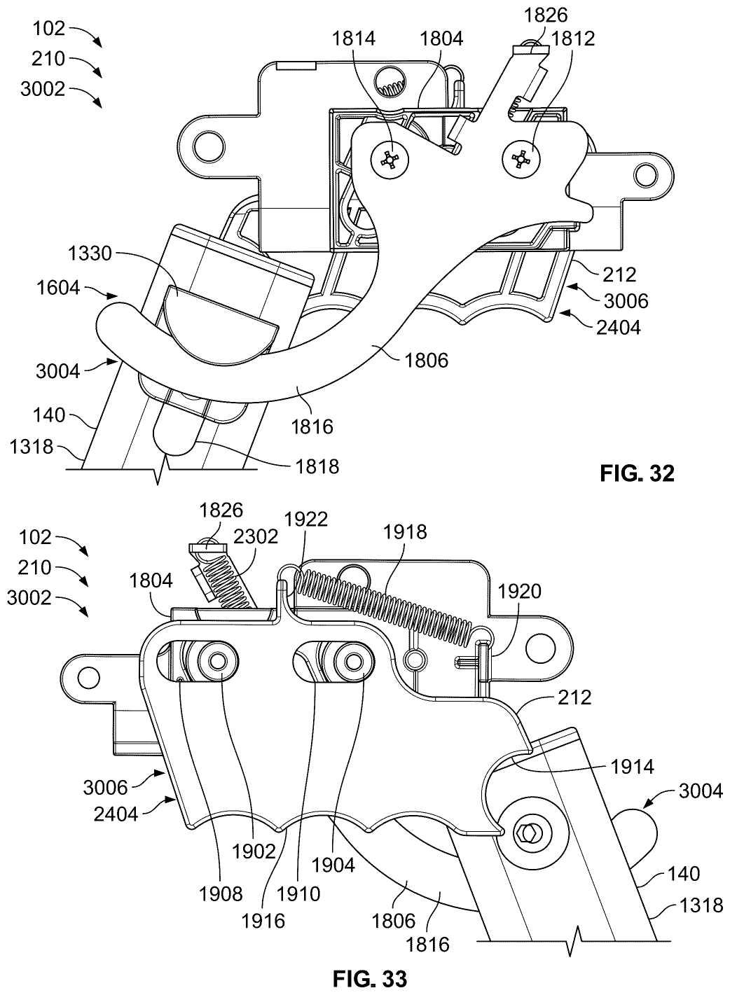

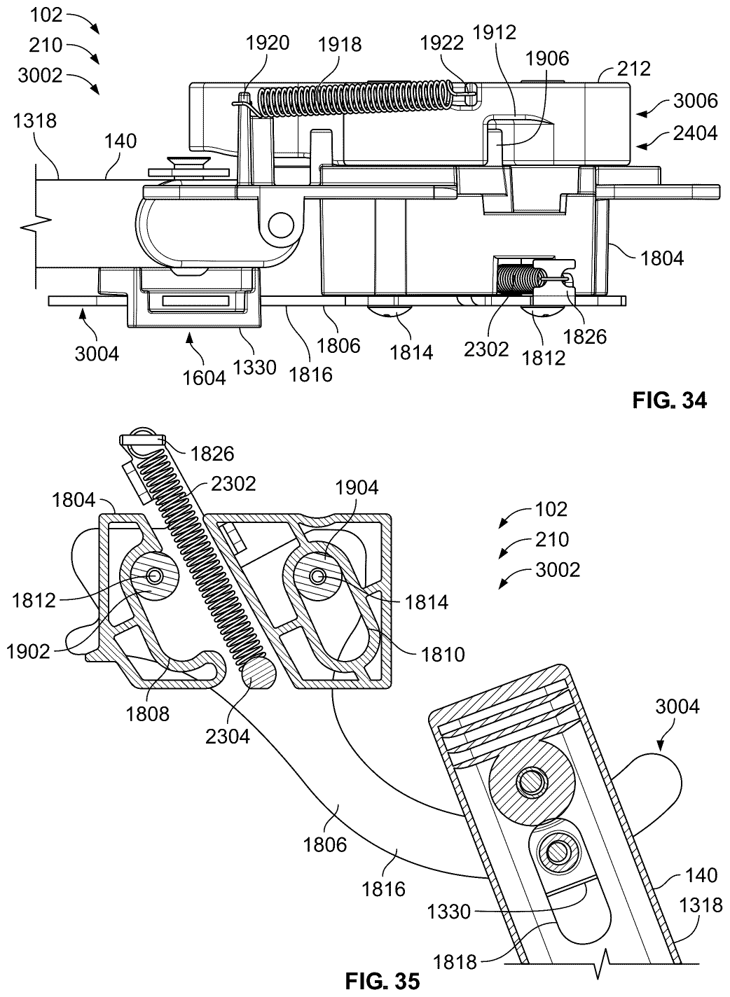

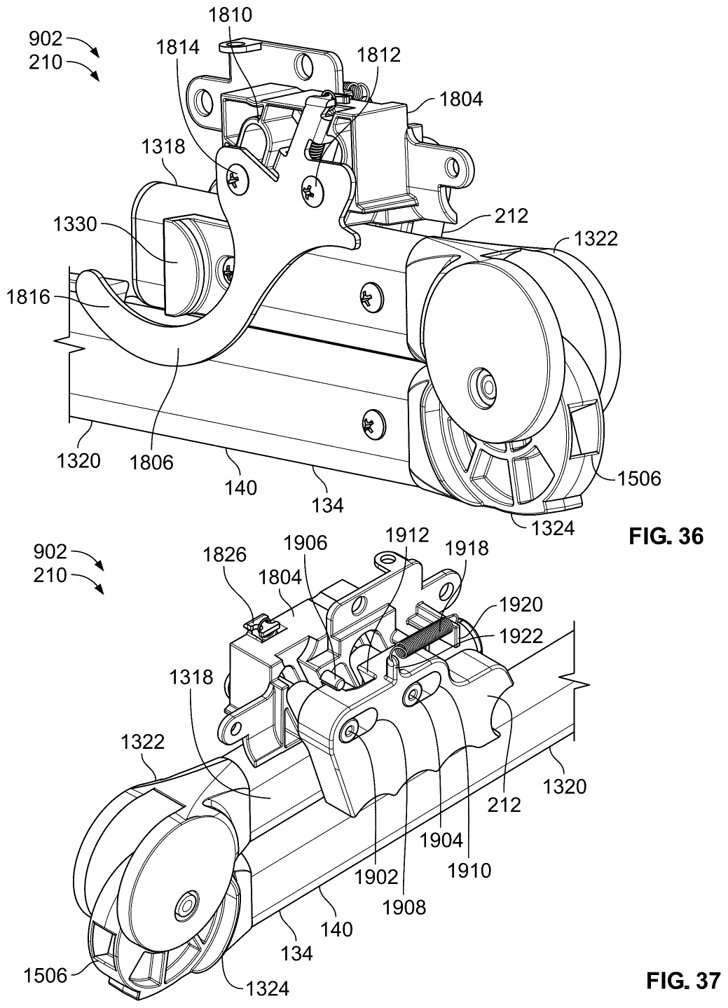

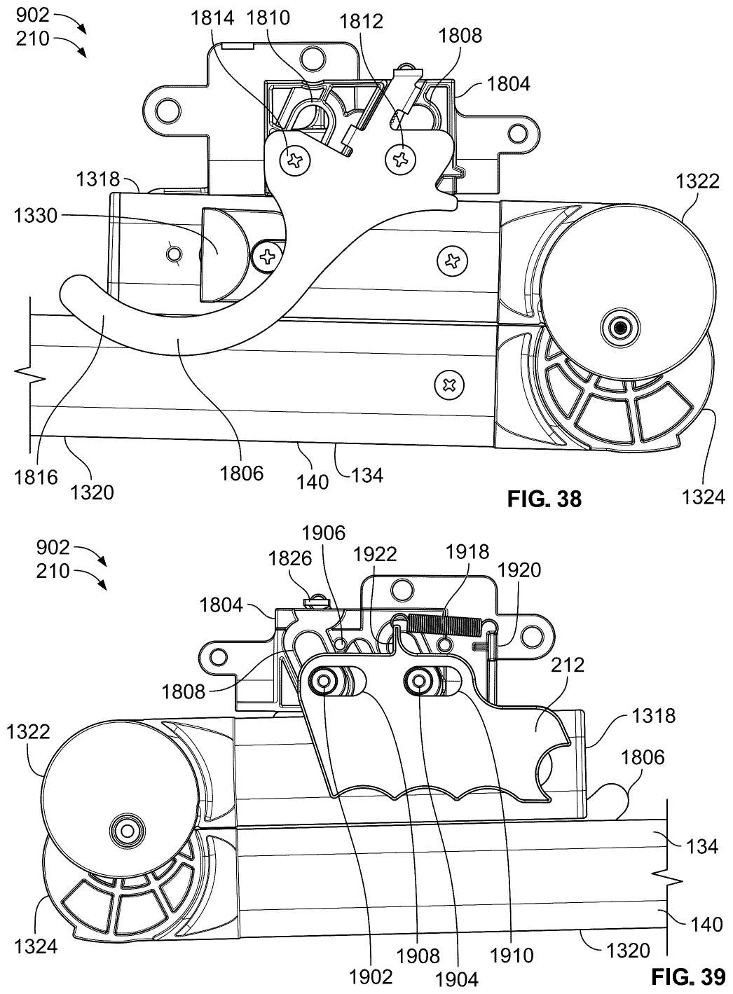

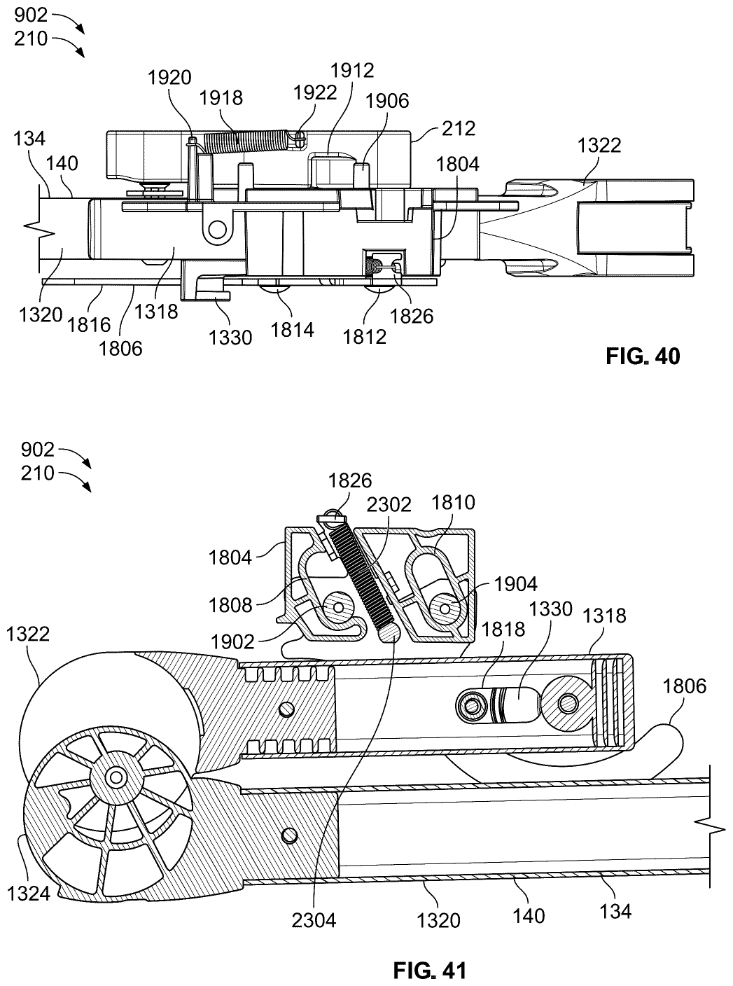

FIG. 18 is a first perspective view of a portion of the portable grill 100 of FIGS. 1-11, with the rear leg 140 of the second leg unit 134 of the portable grill 100 shown in the erected configuration 102 of FIGS. 1-8 and 13-17, and with the leg lock assembly 210 of the portable grill shown in the locked configuration 1802. FIGS. 19-23 respectively provide a second perspective view (FIG. 19), a front view (FIG. 20), a rear view (FIG. 21), a top view (FIG. 22), and a cross-sectional view (FIG. 23) of the portion of the portable grill 100 as shown in FIG. 18. FIG. 24 is a first perspective view of a portion of the portable grill 100 of FIGS. 1-11, with the rear leg 140 of the second leg unit 134 of the portable grill 100 shown in the erected configuration 102 of FIGS. 1-8 and 13-23, and with the leg lock assembly 210 of the portable grill shown in the partially unlocked configuration 2402. FIGS. 25-29 respectively provide a second perspective view (FIG. 25), a front view (FIG. 26), a rear view (FIG. 27), a top view (FIG. 28), and a cross-sectional view (FIG. 29) of the portion of the portable grill 100 as shown in FIG. 24. FIG. 30 is a first perspective view of a portion of the portable grill 100 of FIGS. 1-11, with the rear leg 140 of the second leg unit 134 of the portable grill 100 shown in the erected configuration 102 of FIGS. 1-8 and 13-29, and with the leg lock assembly 210 of the portable grill 100 shown in the unlocked configuration 3002. FIGS. 31-35 respectively provide a second perspective view (FIG. 31), a front view (FIG. 32), a rear view (FIG. 33), a top view (FIG. 34), and a cross-sectional view (FIG. 35) of the portion of the portable grill 100 as shown in FIG. 30. FIG. 36 is a first perspective view of a portion of the portable grill 100 of FIGS. 1-11, with the rear leg 140 of the second leg unit 134 of the portable grill 100 shown in the collapsed configuration 902 of FIGS. 9-11. FIGS. 37-41 respectively provide a second perspective view (FIG. 37), a front view (FIG. 38), a rear view (FIG. 39), a top view (FIG. 40), and a cross-sectional view (FIG. 41) of the portion of the portable grill 100 as shown in FIG. 36.

As shown in FIGS. 18-41, the illustrated portion of the leg lock assembly 210 includes the carriage 1330 and the handle 212 described above, and further includes an example release guide 1804, an example first guide post 1902, an example second guide post 1904, and an example lever 1806. Movements of various ones of the handle 212, the first guide post 1902, the second guide post 1904, the lever 1806, and the carriage 1330 of the leg lock assembly 210 enable the leg lock assembly 210 to be transitioned from the locked configuration 1802 shown in FIGS. 18-23 into the partially unlocked configuration 2402 shown in FIGS. 24-29, and from the partially unlocked configuration 2402 shown in FIGS. 24-29 into the unlocked configuration 3002 shown in FIGS. 30-35, as further described herein. Such movements enable the portable grill 100 to be transitioned from the erected configuration 102 shown in FIGS. 1-8 and 13-35 into the collapsed configuration 902 shown in FIGS. 9-11 and 36-41.

The release guide 1804 of the leg lock assembly 210 of FIGS. 18-41 is configured to be rigidly coupled (e.g., via one or more fastener(s)) to the rear rail 112 of the frame 108 of the portable grill 100. In the illustrated example of FIGS. 18-41, the release guide 1804 of the leg lock assembly 210 includes an example first guide slot 1808, an example second guide slot 1810, and an example release pin 1906. The handle 212 of the leg lock assembly 210 includes an example first release slot 1908, an example second release slot 1910, an example receiver 1912 (e.g., a cavity, channel, or opening configured to receive the release pin 1906), an example pull grip 1914, and an example lift grip 1916. The first guide post 1902 of the leg lock assembly 210 extends from the first guide slot 1808 of the release guide 1804 into the first release slot 1908 of the handle 212, with the first guide post 1902 being slidable within and/or relative to the first guide slot 1808, and with the first release slot 1908 being slidable relative to the first guide post 1902. Similarly, the second guide post 1904 of the leg lock assembly 210 extends from the second guide slot 1810 of the release guide 1804 into the second release slot 1910 of the handle 212, with the second guide post 1904 being slidable within and/or relative to the second guide slot 1810, and with the second release slot 1910 being slidable relative to the second guide post 1904. Movement of the first guide post 1902 and the second guide post 1904 within and/or relative to corresponding ones of the first release slot 1908 and the second release slot 1910 and/or corresponding ones of the first guide slot 1808 and the second guide slot 1810 occurs in a unitary manner, as further described herein.

The lever 1806 of the leg lock assembly 210 is rigidly coupled by an example first fastener 1812 and an example second fastener 1814 to corresponding ones of the first guide post 1902 and the second guide post 1904 of the leg lock assembly 210 such that movement of the lever 1806 occurs in a unitary manner relative to movement of the first guide post 1902 and the second guide post 1904. The lever 1806 of the leg lock assembly 210 includes an example lift arm 1816 that is operatively coupled to and/or otherwise configured to engage with the carriage 1330 of the leg lock assembly 210. In the illustrated example of FIGS. 18-41, the lift arm 1816 of the lever 1806 has a contoured and/or curved shape. In other examples, the lift arm 1816 of the lever 1806 can instead have a linear and/or straightened shape. Movement (e.g., a lifting or raising movement) of the lift arm 1816 and/or, more generally, of the lever 1806 of the leg lock assembly 210 relative to the release guide 1804 of the leg lock assembly 210 causes a corresponding movement (e.g., a lifting or raising movement) of the carriage 1330 within an example slot 1818 formed in the first segment 1318 of the rear leg 140 of the second leg unit 134 of the portable grill 100. For example, the lift arm 1816 of the lever 1806 is movable (e.g., liftable and/or raisable) from an example lowered lever position 1820 shown in FIGS. 18-29 into an example raised lever position 3004 shown in FIGS. 30-35. Moving (e.g., lifting or raising) the lift arm 1816 of the lever 1806 of the leg lock assembly 210 from the lowered lever position 1820 shown in FIGS. 18-29 into the raised lever position 3004 shown in FIGS. 30-35 causes the carriage 1330 of the leg lock assembly 210 to move from the lowered carriage position 1410 shown in FIGS. 14, 15, and 18-29 into the raised carriage position 1604 shown in FIGS. 16, 17, and 30-35.

Upward movement (e.g., a lifting or raising movement) of the lever 1806 of the leg lock assembly 210 from the lowered lever position 1820 shown in of FIGS. 18-29 toward and/or into the raised lever position 3004 shown in FIGS. 30-35 occurs in response to an associated upward movement (e.g., a lifting or raising movement) of the first guide post 1902 and the second guide post 1904 within corresponding ones of the first guide slot 1808 and the second guide slot 1810 of the release guide 1804. Such upward movement (e.g., a lifting or raising movement) of the first guide post 1902 and the second guide post 1904 within corresponding ones of the first guide slot 1808 and the second guide slot 1810 of the release guide 1804 occurs in response to an associated upward movement (e.g., a lifting or raising movement) of the handle 212 of the leg lock assembly 210 from an example lowered handle position 1822 shown in FIGS. 18-29 into an example raised handle position 3006 shown in FIGS. 30-35. Before such movement of the handle 212 can occur, however, the handle 212 must first be moved from an example retracted handle position 1824 shown in FIGS. 18-23 into an example extended handle position 2404 shown in FIGS. 24-35.

Prior to the handle 212 being moved (e.g., slid or pulled) from the retracted handle position 1824 shown in FIGS. 18-23 into the extended handle position 2404 shown in FIGS. 24-35, the release pin 1906 of the release guide 1804 is not aligned with and/or not receivable within the receiver 1912 of the handle 212. The misalignment between the release pin 1906 of the release guide 1804 and the receiver 1912 of the handle 212 prevents and/or blocks the handle 212 of the leg lock assembly 210 from being moved upward (e.g., lifted or raised) relative to the release guide 1804 of the leg lock assembly 210 from the lowered handle position 1822 shown in FIGS. 18-29 toward and/or into the raised handle position 3006 shown in FIGS. 30-35. Moving (e.g., sliding or pulling) the handle 212 from the retracted handle position 1824 shown in FIGS. 18-23 into the extended handle position 2404 shown in FIGS. 24-35 aligns the release pin 1906 of the release guide 1804 with the receiver 1912 of the handle 212 such that the release pin 1906 is receivable within the receiver 1912. The alignment between the release pin 1906 of the release guide 1804 and the receiver 1912 of the handle 212 enables the handle 212 of the leg lock assembly 210 to be moved upward (e.g., lifted or raised) relative to the release guide 1804 of the leg lock assembly 210 from the lowered handle position 1822 shown in FIGS. 18-29 toward and/or into the raised handle position 3006 shown in FIGS. 30-35

Movement of the handle 212 from the retracted handle position 1824 shown in FIGS. 18-23 toward and/or into the extended handle position 2404 shown in FIGS. 24-35 can occur via a pulling motion manually applied to the pull grip 1914 of the handle 212, thereby resulting in the handle 212 being moved in a lateral direction (e.g., toward the right side rail 114 of the frame 108 of the portable grill 100). Such movement of the handle 212 from the retracted handle position 1824 toward and/or into the extended handle position 2404 occurs against a biasing force generated by an example second tension spring 1918 of the leg lock assembly 210. In the illustrated example of FIGS. 18-41, the second tension spring 1918 of the leg lock assembly 210 includes a first end coupled to an example first mount 1920 that is coupled to and/or integrally formed with the release guide 1804 of the leg lock assembly 210, and a second end coupled to an example second mount 1922 that is coupled to and/or integrally formed with the handle 212 of the leg lock assembly 210. The second tension spring 1918 biases the handle 212 of the leg lock assembly 210 into the retracted handle position 1824 shown in FIGS. 18-23 and away from the extended handle position 2404 shown in FIGS. 24-35. The handle 212 of the leg lock assembly 210 accordingly remains in the retracted handle position 1824 until a pulling force sufficient to overcome the biasing force associated with the second tension spring 1918 is applied to the handle 212, with the pulling force being applied (e.g., via the pull grip 1914 of the handle 212) in a lateral direction that moves the handle 212 away from the retracted handle position 1824 shown in FIGS. 18-23 toward and/or into the extended handle position 2404 shown in FIGS. 24-35.

Movement of the handle 212 from the lowered handle position 1822 shown in FIGS. 18-29 toward and/or into the raised handle position 3006 shown in FIGS. 30-35 can occur via a lifting motion manually applied to the lift grip 1916 of the handle 212, thereby resulting in the handle 212 being moved in an upward direction (e.g., toward the 118 of the portable grill 100). Such movement of the handle 212 from the lowered handle position 1822 toward and/or into the raised handle position 3006 occurs against a biasing force generated by an example third tension spring 2302 of the leg lock assembly 210. In the illustrated example of FIGS. 18-41, the third tension spring 2302 of the leg lock assembly 210 includes a first end coupled to an example first mount 2304 that is coupled to and/or integrally formed with the release guide 1804 of the leg lock assembly 210, and a second end coupled to an example second mount 1826 that is coupled to and/or integrally formed with the lever 1806 of the leg lock assembly 210. The third tension spring 2302 biases the handle 212 of the leg lock assembly 210 (e.g., along with the first guide post 1902, the second guide post 1904, and the lever 1806 of the leg lock assembly 210) into the lowered handle position 1822 shown in FIGS. 18-29 and away from the raised handle position 3006 shown in FIGS. 30-35. The handle 212 of the leg lock assembly 210 accordingly remains in the lowered handle position 1822 until a lifting force sufficient to overcome the biasing force associated with the third tension spring 2302 is applied to the handle 212, with the lifting force being applied (e.g., via the lift grip 1916 of the handle 212) in an upward direction that moves the handle 212 away from the lowered handle position 1822 shown in FIGS. 18-29 toward and/or into the raised handle position 3006 shown in FIGS. 30-35.

FIGS. 18-23 illustrate the leg lock assembly 210 of the portable grill 100 in the locked configuration 1802. When the leg lock assembly 210 is in the locked configuration 1802 of FIGS. 18-23, the handle 212 of the leg lock assembly 210 is in the retracted handle position 1824, and remains held in that position based on the biasing force of the second tension spring 1918 of the leg lock assembly 210. In addition to being in the retracted handle position 1824, the handle 212 of the leg lock assembly 210 is also in the lowered handle position 1822, and remains held in that position primarily based on the misalignment between the release pin 1906 of the release guide 1804 and the receiver 1912 of the handle 212, and further based on the biasing force of the third tension spring 2302 of the leg lock assembly 210. When the leg lock assembly 210 is in the locked configuration 1802 of FIGS. 18-23, the first guide post 1902 and the second guide post 1904 are in lowered positions corresponding to the lowered handle position 1822 of the handle, which in turn causes the lever 1806 of the leg lock assembly 210 to be in the lowered lever position 1820. As a result of the lever 1806 of the leg lock assembly 210 being in the lowered lever position 1820, the carriage 1330 of the leg lock assembly 210 is in the lowered carriage position 1410. As a result of the carriage 1330 of the leg lock assembly 210 being in the lowered carriage position 1410, the plunger 1402 of the leg lock assembly 210 is in the locked position 1404 shown in FIGS. 14 and 15. As a result of the plunger 1402 being in the locked position 1404, the second hinge member 1324 of the rear leg 140 is locked relative to the first hinge member 1322 of the rear leg 140 such that the second hinge member 1324 of the rear leg 140 cannot move (e.g., cannot rotate) relative to the first hinge member 1322 of the rear leg 140, and/or such that the second segment 1320 of the rear leg 140 cannot move (e.g., cannot rotate) relative to the first segment 1318 of the rear leg 140. The locked configuration 1802 of the leg lock assembly 210 accordingly prevents the portable grill 100 from being transitioned from the erected configuration 102 shown in FIGS. 1-8 into the collapsed configuration 902 shown in FIGS. 9-11.

FIGS. 24-29 illustrate the leg lock assembly 210 of the portable grill 100 in the partially unlocked configuration 2402. A user of the portable grill 100 can transition the leg lock assembly 210 from the locked configuration 1802 shown in FIGS. 18-23 into the partially unlocked configuration 2402 shown in FIGS. 24-29 by moving (e.g., pulling) the handle 212 of the leg lock assembly 210 from the retracted handle position 1824 shown in FIGS. 18-23 toward and/or into the extended handle position 2404 shown in FIGS. 24-29. When the leg lock assembly 210 is in the partially unlocked configuration 2402 of FIGS. 24-29, the handle 212 of the leg lock assembly 210 is in the extended handle position 2404. In addition to being in the extended handle position 2404, the handle 212 of the leg lock assembly 210 is also in the lowered handle position 1822, and remains held in that position based on the biasing force of the third tension spring 2302 of the leg lock assembly 210. When the leg lock assembly 210 is in the partially unlocked configuration 2402 of FIGS. 24-29, the first guide post 1902 and the second guide post 1904 are in lowered positions corresponding to the lowered handle position 1822 of the handle, which in turn causes the lever 1806 of the leg lock assembly 210 to be in the lowered lever position 1820. As a result of the lever 1806 of the leg lock assembly 210 being in the lowered lever position 1820, the carriage 1330 of the leg lock assembly 210 is in the lowered carriage position 1410. As a result of the carriage 1330 of the leg lock assembly 210 being in the lowered carriage position 1410, the plunger 1402 of the leg lock assembly 210 is in the locked position 1404 shown in FIGS. 14 and 15. As a result of the plunger 1402 being in the locked position 1404, the second hinge member 1324 of the rear leg 140 is locked relative to the first hinge member 1322 of the rear leg 140 such that the second hinge member 1324 of the rear leg 140 cannot move (e.g., cannot rotate) relative to the first hinge member 1322 of the rear leg 140, and/or such that the second segment 1320 of the rear leg 140 cannot move (e.g., cannot rotate) relative to the first segment 1318 of the rear leg 140. The partially unlocked configuration 2402 of the leg lock assembly 210 accordingly still prevents the portable grill 100 from being transitioned from the erected configuration 102 shown in FIGS. 1-8 into the collapsed configuration 902 shown in FIGS. 9-11.

FIGS. 30-35 illustrate the leg lock assembly 210 of the portable grill 100 in the unlocked configuration 3002. A user of the portable grill 100 can transition the leg lock assembly 210 from the partially unlocked configuration 2402 shown in FIGS. 24-29 into the unlocked configuration 3002 shown in FIGS. 30-35 by moving (e.g., lifting) the handle 212 of the leg lock assembly 210 from the lowered handle position 1822 shown in FIGS. 18-29 toward and/or into the raised handle position 3006 shown in FIGS. 30-35. When the leg lock assembly 210 is in the unlocked configuration 3002 of FIGS. 30-35, the handle 212 of the leg lock assembly 210 is in the extended handle position 2404, and is also in the raised handle position 3006. When the leg lock assembly 210 is in the unlocked configuration 3002 of FIGS. 30-35, the first guide post 1902 and the second guide post 1904 are in raised positions corresponding to the raised handle position 3006 of the handle, which in turn causes the lever 1806 of the leg lock assembly 210 to be in the raised lever position 3004. As a result of the lever 1806 of the leg lock assembly 210 being in the raised lever position 3004, the carriage 1330 of the leg lock assembly 210 is in the raised carriage position 1604. As a result of the carriage 1330 of the leg lock assembly 210 being in the raised carriage position 1604, the plunger 1402 of the leg lock assembly 210 is in the unlocked position 1602 shown in FIGS. 16 and 17. As a result of the plunger 1402 being in the unlocked position 1602, the second hinge member 1324 of the rear leg 140 is unlocked from and/or no longer locked relative to the first hinge member 1322 of the rear leg 140 such that the second hinge member 1324 of the rear leg 140 is movable (e.g., rotatable) relative to the first hinge member 1322 of the rear leg 140, and/or such that the second segment 1320 of the rear leg 140 is movable (e.g., rotatable) relative to the first segment 1318 of the rear leg 140. The unlocked configuration 3002 of the leg lock assembly 210 accordingly enables the portable grill 100 to be transitioned from the erected configuration 102 shown in FIGS. 1-8 into the collapsed configuration 902 shown in FIGS. 9-11.

FIGS. 36-41 illustrate the portable grill 100 in the collapsed configuration 902 of FIGS. 9-11, with the portable grill 100 having been transitioned into the collapsed configuration 902 from the erected configuration 102 as a result of the leg lock assembly 210 of the portable grill 100 being placed into the unlocked configuration 3002 of FIGS. 30-35 described above. In some examples, the weight of the cookbox 104, the lid 106, the frame 108, and/or other component(s) of the portable grill 100 cause the portable grill 100 to automatically transition from the erected configuration 102 shown in FIGS. 1-8 and 13-35 toward and/or into the collapsed configuration 902 shown in FIGS. 9-11 and 36-41 in response to the leg lock assembly 210 of the portable grill 100 being transitioned into the unlocked configuration 3002 of FIGS. 30-35 described above. The leg lock assembly 210 of the portable grill 100 is configured to be automatically reset into the locked configuration 1802 of FIGS. 18-23 described above in response to the portable grill 100 being transitioned (e.g., manually transitioned by a user of the portable grill 100) from the collapsed configuration 902 back into the erected configuration 102.

The portable grill 100 of FIGS. 1-11 further includes an example tank blocker 152 configured to restrict (e.g., prevent) the portable grill 100 from being transitioned from the erected configuration 102 shown in FIGS. 1-8 and 13-35 into the collapsed configuration 902 shown in FIGS. 9-11 and 36-41 when a fuel tank that is removably couplable to the portable grill 100 (e.g., via a threaded connection formed between the fuel tank and a tank connector of the valve and regulator assembly 204) remains coupled to the portable grill 100. In some examples, the tank blocker 152 is operatively coupled to the above-described leg lock assembly 210 and to an attached fuel tank of the portable grill 100 such that movement of the tank blocker 152 from a blocked configuration (e.g., which prevents movement of the lever 1806 of the leg lock assembly 210 from the lowered lever position 1820 shown in FIGS. 18-29 into the raised lever position 3004 shown in FIGS. 30-35, and accordingly prevents movement of the handle 212 of the leg lock assembly 210 from the lowered handle position 1822 shown in FIGS. 18-29 into the raised handle position 3006 shown in FIGS. 30-35) into an unblocked configuration (e.g., which enables movement of the lever 1806 of the leg lock assembly 210 from the lowered lever position 1820 shown in FIGS. 18-29 into the raised lever position 3004 shown in FIGS. 30-35, and accordingly enables movement of the handle 212 of the leg lock assembly 210 from the lowered handle position 1822 shown in FIGS. 18-29 into the raised handle position 3006 shown in FIGS. 30-35) occurs automatically in response to the attached fuel tank becoming uncoupled and/or detached from the portable grill 100. Thus, the tank blocker 152 advantageously provides a mechanically-automated failsafe against the possibility of a user of the portable grill 100 failing to uncouple and/or remove the fuel tank from the portable grill 100 prior to initiating the transition of the portable grill 100 from the erected configuration 102 into the collapsed configuration 902.

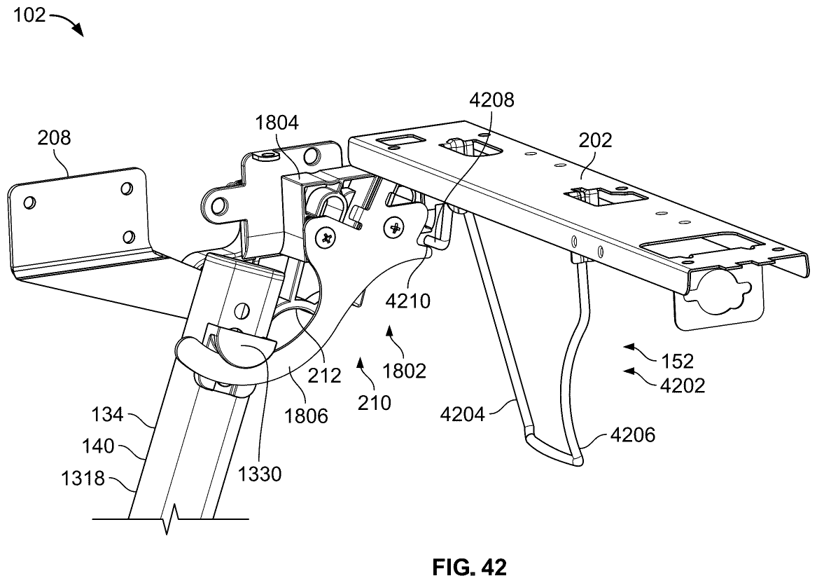

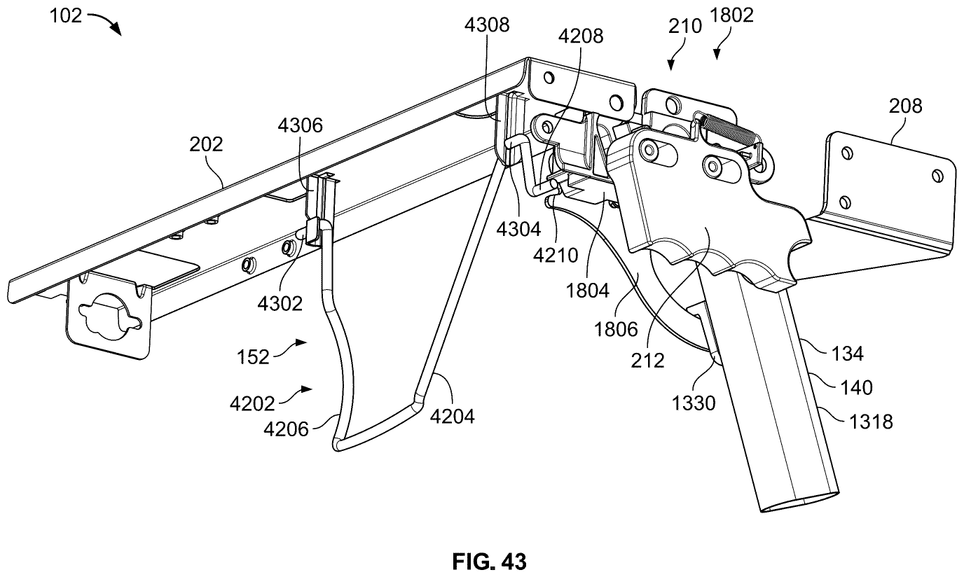

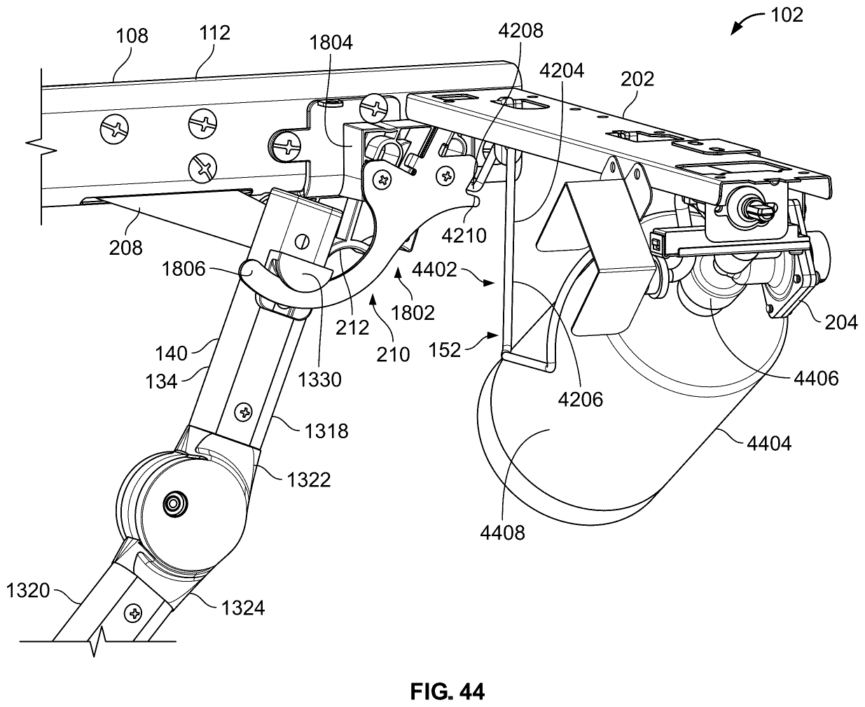

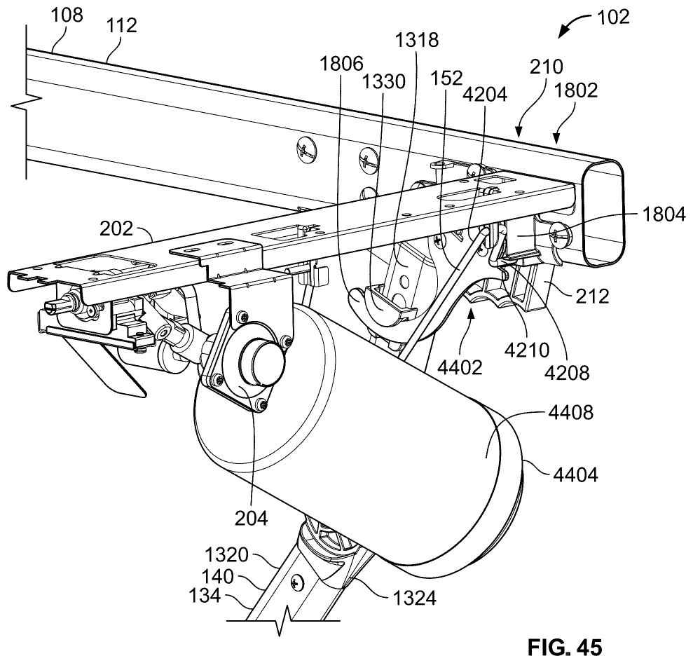

FIGS. 42 and 43 illustrate the tank blocker 152 of the portable grill 100 in greater detail. FIG. 42 is a first perspective view of a portion of the portable grill 100 of FIGS. 1-11, with the leg lock assembly 210 of the portable grill 100 shown in the locked configuration 1802 of FIGS. 18-23, and with the tank blocker 152 of the portable grill 100 shown in an example non-blocking position 4202. FIG. 43 is a second perspective view of the portion of the portable grill 100 as shown in FIG. 42. As shown in FIGS. 42 and 43, the tank blocker 152 is carried by, suspended from, and/or pivotally coupled to the support member 202 of the portable grill 100 such that the tank blocker 152 hangs downwardly from and is pivotal relative to the support member 202. In the illustrated example of FIGS. 42 and 43, the tank blocker 152 is implemented as an example wire form 4204 including an example first arm 4302, an example second arm 4304, and an example central portion 4206 extending between the first arm 4302 and the second arm 4304. The first arm 4302 and the second arm 4304 of the wire form 4204 are pivotally coupled to the support member 202 via corresponding ones of an example first flange 4306 and an example second flange 4308 that extend downwardly from the support member 202. The central portion 4206 of the wire form 4204 includes a segment having a contoured and/or curved profile configured to complement (e.g., match) a contoured and/or curved profile of a fuel tank (e.g., the fuel tank 4404 of FIGS. 44 and 45) that is removably couplable to the portable grill 100.

The wire form 4204 of the tank blocker 152 further includes an example blocking pin 4208 configured to selectively engage and/or to selectively be located within an example notch 4210 formed in the lever 1806 of the leg lock assembly 210 of the portable grill 100. In the illustrated example of FIGS. 42 and 43, the blocking pin 4208 of the wire form 4204 is formed by and/or as a free end of the wire form 4204 that is coupled to (e.g., integrally formed with) and extends from the second arm 4304 of the wire form 4204. When the wire form 4204 and/or, more generally, the tank blocker 152 of the portable grill 100 is in the non-blocking position 4202 shown in FIGS. 42 and 43, the blocking pin 4208 of the wire form 4204 does not engage and/or is not located within the notch 4210 of the lever 1806 of the leg lock assembly 210. When the blocking pin 4208 of the wire form 4204 does not engage and/or is not located within the notch 4210 of the lever 1806 of the leg lock assembly 210, the lever 1806 of the leg lock assembly 210 is able to be moved (e.g., lifted or raised) from the lowered lever position 1820 shown in FIGS. 18-29 into the raised lever position 3004 shown in FIGS. 30-35, which can be accomplished by moving (e.g., manually lifting or raising) the handle 212 of the leg lock assembly 210 from the lowered handle position 1822 shown in FIGS. 18-29 into the raised handle position 3006 shown in FIGS. 30-35.

FIG. 44 is a first perspective view of a portion of the portable grill 100 of FIGS. 1-11, with the leg lock assembly 210 of the portable grill 100 shown in the locked configuration 1802 of FIGS. 18-23, 42, and 43, and with the tank blocker 152 of the portable grill 100 shown in an example blocking position 4402. FIG. 45 is a second perspective view of the portion of the portable grill 100 as shown in FIG. 44. The wire form 4204 and/or, more generally, the tank blocker 152 of the portable grill 100 is configured to move (e.g., rotate) relative to the support member 202 of the portable grill 100 from the non-blocking position 4202 shown in FIGS. 42 and 43 into the blocking position 4402 shown in FIGS. 44 and 45 in response to an example fuel tank 4404 becoming and/or being connected and/or attached (e.g., threadedly coupled) to an example connector 4406 of the valve and regulator assembly 204 of the portable grill 100. In this regard, the act of manually coupling and/or attaching the fuel tank 4404 to the connector 4406 of the valve and regulator assembly 204 causes an example surface 4408 (e.g., a sidewall) of the fuel tank 4404 to contact the central portion 4206 of the wire form 4204 in a manner that pivots the wire form 4204 toward and/or into the blocking position 4402 shown in FIGS. 44 and 45.

When the fuel tank 4404 is connected, attached, and/or coupled to the connector 4406 of the valve and regulator assembly 204 as shown in FIGS. 44 and 45, the repositioning of the wire form 4204 of the tank blocker 152 resulting from the physical and/or spatial presence of the fuel tank 4404 (e.g., the surface 4408 of the fuel tank 4404 contacting the central portion 4206 of the wire form 4204) causes the blocking pin 4208 of the wire form 4204 to engage and/or to be located within the notch 4210 of the lever 1806 of the leg lock assembly 210. When the blocking pin 4208 of the wire form 4204 engages and/or is located within the notch 4210 of the lever 1806 of the leg lock assembly 210, the lever 1806 of the leg lock assembly 210 is blocked and/or prevented from being moved (e.g., lifted or raised) from the lowered lever position 1820 shown in FIGS. 18-29 into the raised lever position 3004 shown in FIGS. 30-35. Such blocking and/or prevention occurs even when the handle 212 of the leg lock assembly 210 is in both the extended handle position 2404 and the lowered handle position 1822 associated with the partially unlocked configuration 2402 of the leg lock assembly 210 shown in FIGS. 24-29, such that the handle 212 would otherwise (e.g., if the tank blocker 152 were instead in the non-blocking position 4202 of FIGS. 42 and 43) be able to be moved (e.g., lifted or raised) into the raised handle position 3006 shown in FIGS. 30-35.

Positioning the wire form 4204 and/or, more generally, the tank blocker 152 in the blocking position 4402 shown in FIGS. 44 and 45 accordingly blocks and/or prevents the leg lock assembly 210 of the portable grill 100 from being transitioned from the partially unlocked configuration 2402 shown in FIGS. 24-29 toward and/or into the unlocked configuration 3002 shown in FIGS. 30-35, which in turn blocks and/or prevents the portable grill 100 from being transitioned from the erected configuration 102 shown FIGS. 1-8 and 13-35 toward and/or into the collapsed configuration 902 shown in FIGS. 9-11 and 36-41. Such blocking and/or prevention continues until the fuel tank 4404 is manually disconnected and/or uncoupled from the connector 4406 of the valve and regulator assembly 204, at which time the wire form 4204 and/or, more generally, the tank blocker 152 of the portable grill 100 returns (e.g., under the application of gravity) from the blocking position 4402 shown in FIGS. 44 and 45 toward and/or into the non-blocking position 4202 shown in FIGS. 42 and 43. Once the wire form 4204 and/or, more generally, the tank blocker 152 of the portable grill 100 has returned to the non-blocking position 4202, the leg lock assembly 210 of the portable grill 100 is once again free to be transitioned from the partially unlocked configuration 2402 shown in FIGS. 24-29 toward and/or into the unlocked configuration 3002 shown in FIGS. 30-35, which in turn enables the portable grill 100 to be transitioned from the erected configuration 102 shown FIGS. 1-8 and 13-35 toward and/or into the collapsed configuration 902 shown in FIGS. 9-11 and 36-41.

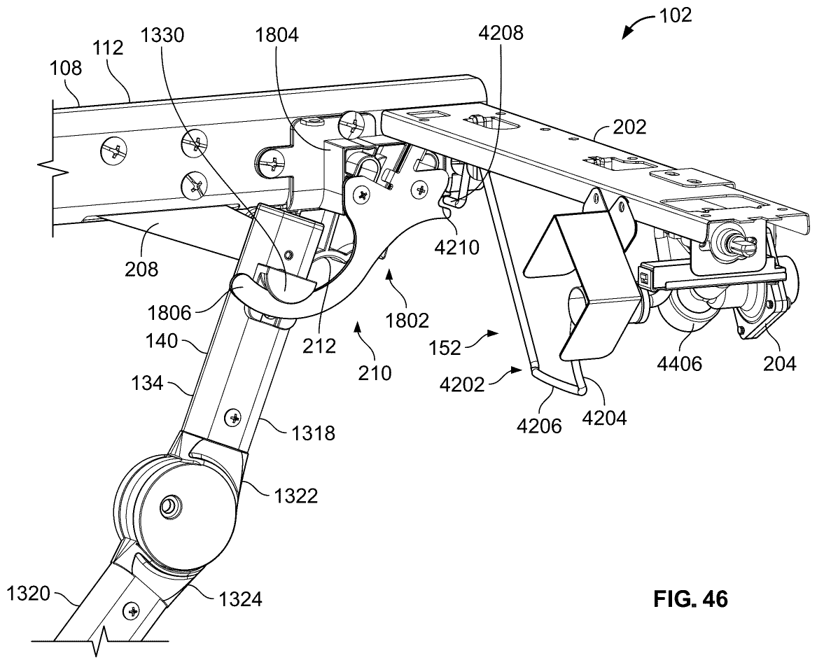

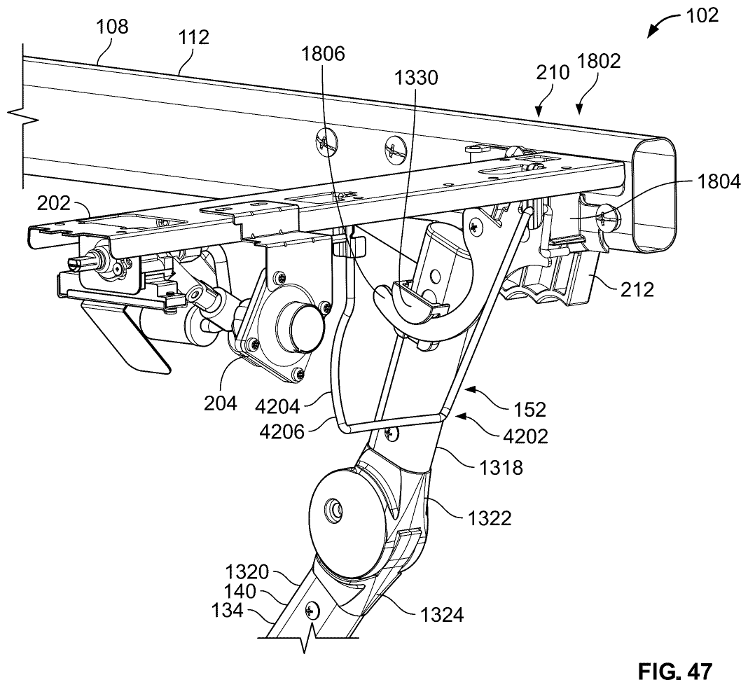

The wire form 4204 and/or, more generally, the tank blocker 152 of the portable grill 100 remains in the non-blocking position 4202 shown in FIGS. 42 and 43 when there is no fuel tank 4404 connected to the connector 4406 of the valve and regulator assembly 204 of the portable grill 100. For example, FIGS. 46 and 47 illustrate the tank blocker 152 having returned from the blocking position 4402 shown in FIGS. 44 and 45 into the non-blocking position 4202 following the disconnection and/or uncoupling of the fuel tank 4404 from the connector 4406 of the valve and regulator assembly 204. In this regard, FIG. 46 is a first perspective view of a portion of the portable grill 100 of FIGS. 1-11, with the leg lock assembly 210 of the portable grill 100 shown in the locked configuration 1802 of FIGS. 18-23 and 42-45, and with the tank blocker 152 of the portable grill 100 shown in the non-blocking position 4202 of FIGS. 42 and 43. FIG. 47 is a second perspective view of the portion of the portable grill 100 as shown in FIG. 46. When the wire form 4204 and/or, more generally, the tank blocker 152 of the portable grill 100 is in the non-blocking position 4202 shown in FIGS. 46 and 47, the leg lock assembly 210 of the portable grill 100 is free to be transitioned from the locked configuration 1802 shown in FIGS. 18-23 and 42-47 toward and/or into the partially unlocked configuration 2402 shown in FIGS. 24-29.

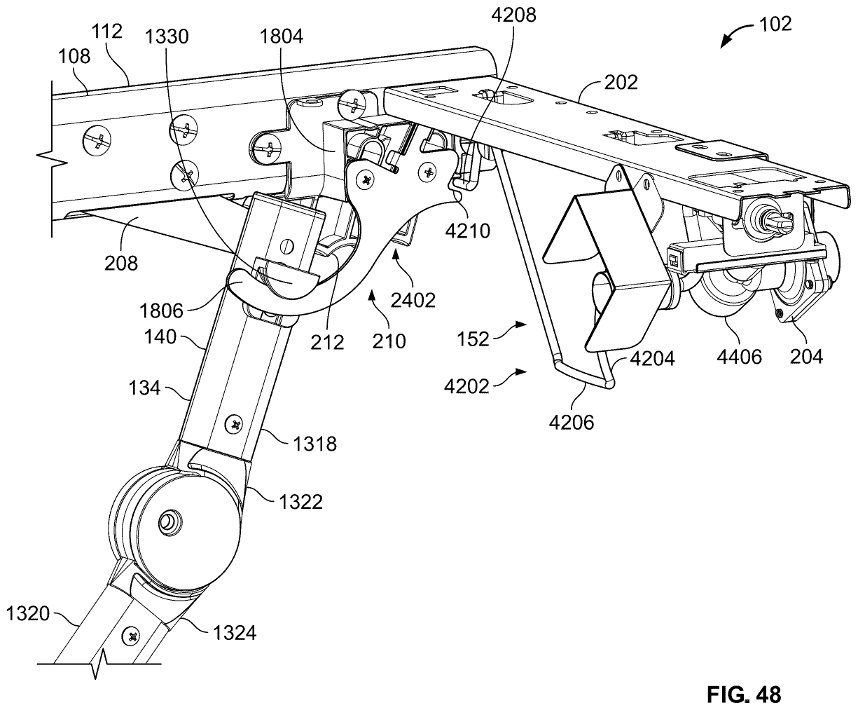

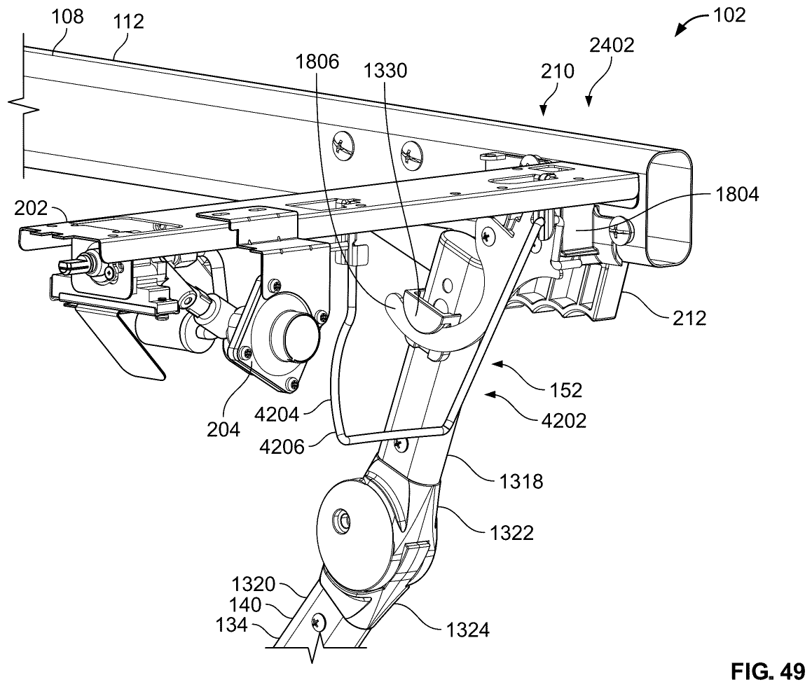

FIG. 48 is a first perspective view of a portion of the portable grill 100 of FIGS. 1-11, with the leg lock assembly 210 of the portable grill 100 shown in the partially unlocked configuration 2402 of FIGS. 24-29, and with the tank blocker 152 of the portable grill 100 shown in the non-blocking position 4202 of FIGS. 42, 43, 46, and 47. FIG. 49 is a second perspective view of the portion of the portable grill 100 as shown in FIG. 48. When the wire form 4204 and/or, more generally, the tank blocker 152 of the portable grill 100 is in the non-blocking position 4202 shown in FIGS. 48 and 49, the leg lock assembly 210 of the portable grill 100 is free to be transitioned from the partially unlocked configuration 2402 shown in FIGS. 24-29 toward and/or into the unlocked configuration 3002 shown in FIGS. 30-35.

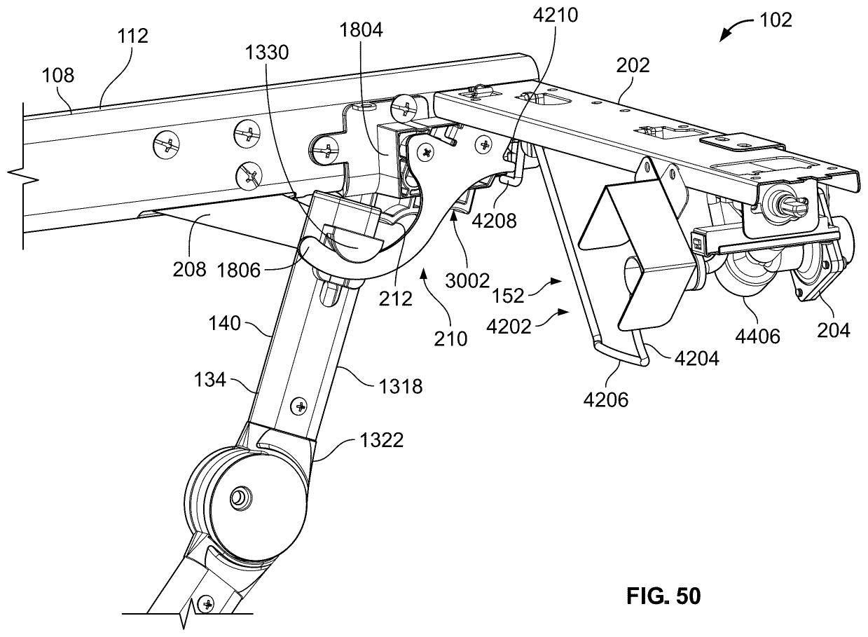

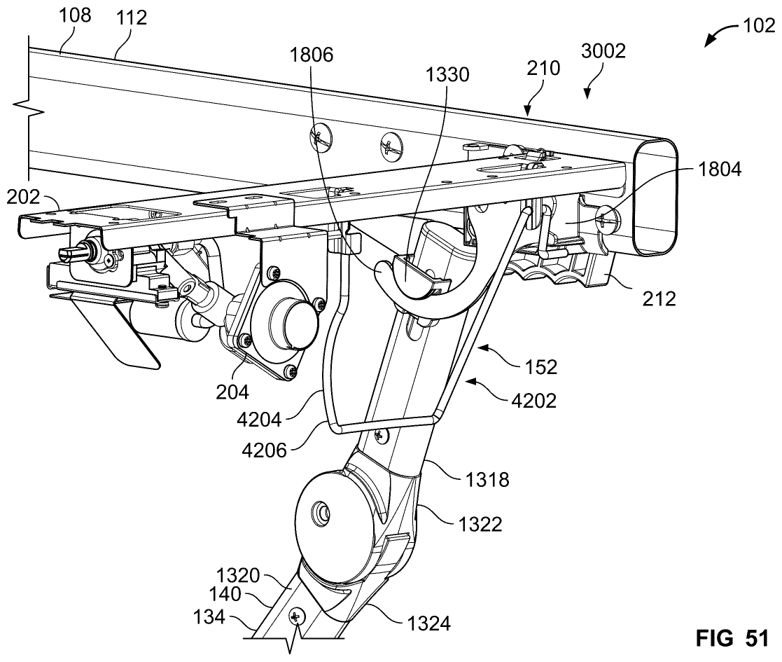

FIG. 50 is a first perspective view of a portion of the portable grill 100 of FIGS. 1-11, with the leg lock assembly 210 of the portable grill 100 shown in the unlocked configuration 3002 of FIGS. 30-35, and with the tank blocker 152 of the portable grill 100 shown in the non-blocking position 4202 of FIGS. 42, 43, and 46-49. FIG. 51 is a second perspective view of the portion of the portable grill 100 as shown in FIG. 50. When the wire form 4204 and/or, more generally, the tank blocker 152 of the portable grill 100 is in the non-blocking position 4202 shown in FIGS. 50 and 51, and the leg lock assembly 210 is in the unlocked configuration 3002, the portable grill 100 is free to be transitioned from the erected configuration 102 toward and/or into the collapsed configuration 902.

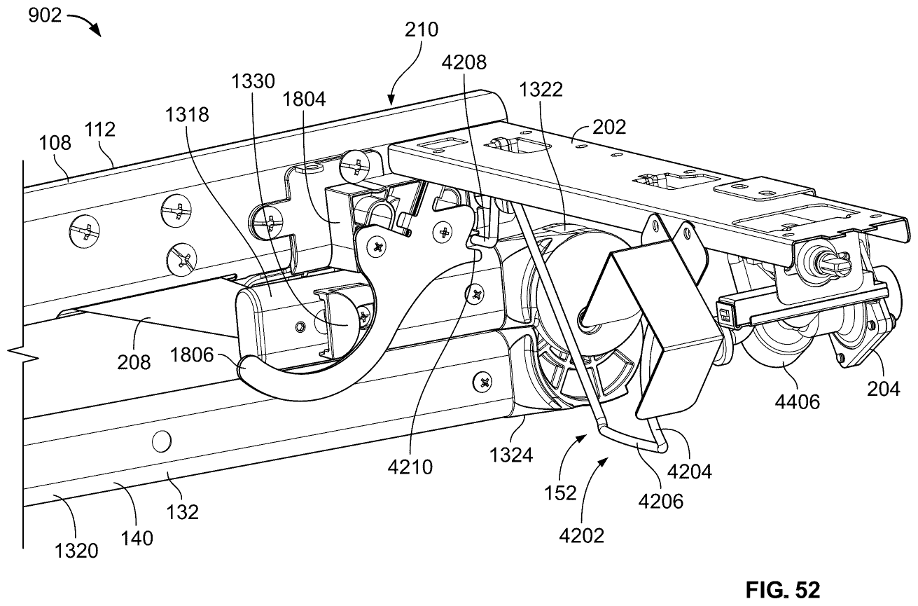

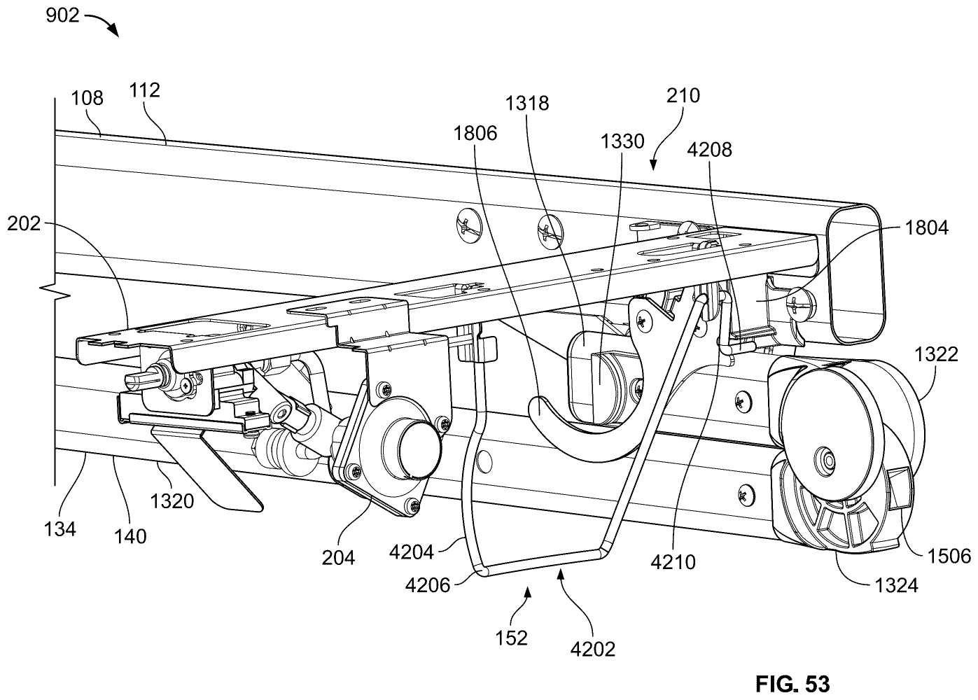

FIGS. 52 and 53 illustrate the portable grill 100 having transitioned from the erected configuration 102 into the collapsed configuration 902. In this regard, FIG. 52 is a first perspective view of a portion of the portable grill 100 of FIGS. 1-11, with the rear leg 140 of the second leg unit 134 shown in the collapsed configuration 902 of FIGS. 9-11 and 36-41, and with the tank blocker 152 of the portable grill 100 shown in the non-blocking position 4202 of FIGS. 42, 43, and 46-51. FIG. 53 is a second perspective view of the portion of the portable grill 100 as shown in FIG. 52. When the wire form 4204 and/or, more generally, the tank blocker 152 of the portable grill 100 is in the non-blocking position 4202 shown in FIGS. 52 and 53, the portable grill 100 is free to be transitioned from the collapsed configuration 902 toward and/or into the erected configuration 102.

The following paragraphs provide various examples in relation to the disclosed accessory support frames for grills.

Example 1 includes a portable grill configured to be transitioned between an erected configuration and a collapsed configuration. In Example 1, the portable grill includes a frame, a first leg unit, and a second leg unit. The frame supports a cookbox. The first leg unit is pivotally coupled to the frame. The first leg unit includes a front leg and a rear leg. The rear leg of the first leg unit is spaced apart from the front leg of the first leg unit. The second leg unit is pivotally coupled to the frame and pivotally coupled to the first leg unit. The second leg unit includes a front leg and a rear leg. The front leg of the second leg unit is pivotally coupled to the front leg of the first leg unit. The front leg of the second leg unit includes a first segment, a second segment, and a hinge located between the first segment and the second segment of the front leg. The hinge of the front leg pivotally couples the first segment of the front leg to the second segment of the front leg. The rear leg of the second leg unit is spaced apart from the front leg of the second leg unit. The rear leg of the second leg unit is pivotally coupled to the rear leg of the first leg unit. The rear leg of the second leg unit includes a first segment, a second segment, and a hinge located between the first segment and the second segment of the rear leg. The hinge of the rear leg pivotally couples the first segment of the rear leg to the second segment of the rear leg.

Example 2 includes the portable grill of Example 1. In Example 2, the rear leg of the second leg unit includes a first hinge member and a second hinge member. The first hinge member is coupled to the first segment of the rear leg. The second hinge member is coupled to the second segment of the rear leg and pivotally coupled to the first hinge member. The first hinge member and the second hinge member define the hinge of the rear leg.

Example 3 includes the portable grill of Example 2. In Example 3, the portable grill further includes a leg lock assembly operatively coupled to the second leg unit. The leg lock assembly includes a plunger having an end selectively positioned within a cavity of the second hinge member. The plunger is movable relative to the first segment of the rear leg between a locked position in which the end of the plunger is positioned within the cavity and an unlocked position in which the end of the plunger is removed from the cavity.

Example 4 includes the portable grill of Example 3. In Example 4, positioning the plunger in the locked position prevents the portable grill from transitioning from the erected configuration into the collapsed configuration, and positioning the plunger in the unlocked position enables the portable grill to be transitioned from the erected configuration into the collapsed configuration.

Example 5 includes the portable grill of Example 3. In Example 5, positioning the plunger in the locked position prevents the second hinge member from rotating relative to the first hinge member, and positioning the plunger in the unlocked position enables the second hinge member to rotate relative to the first hinge member.

Example 6 includes the portable grill of Example 3. In Example 6, positioning the plunger in the locked position prevents the second segment of the rear leg from moving relative to the first segment of the rear leg, and positioning the plunger in the unlocked position enables the second segment of the rear leg to move relative to the first segment of the rear leg.

Example 7 includes the portable grill of Example 3. In Example 7, the plunger is located at least partially within the first segment of the rear leg.

Example 8 includes the portable grill of Example 3. In Example 8, the leg lock assembly further includes a tension spring coupled to a first mount and a second mount. The first mount is coupled to the plunger. The second mount is coupled to the rear leg of the second leg unit. The tension spring is configured to bias the plunger into the locked position.

Example 9 includes the portable grill of Example 3. In Example 9, the leg lock assembly further includes a carriage coupled to the plunger. The carriage is movable relative to the first segment of the rear leg between a lowered carriage position and a raised carriage position. The plunger is in the locked position when the carriage is in the lowered carriage position. The plunger is in the unlocked position when the carriage is in the raised carriage position.

Example 10 includes the portable grill of Example 9. In Example 10, the leg lock assembly further includes a release guide, a handle, and a lever. The release guide is coupled to the frame. The handle is movably coupled to the release guide and operatively coupled to the lever. The lever is operatively coupled to the carriage.

Example 11 includes the portable grill of Example 10. In Example 11, the lever is movable relative to the release guide between a lowered lever position and a raised lever position. The carriage is in the lowered carriage position when the lever is in the lowered lever position. The carriage is in the raised carriage position when the lever is in the raised lever position.

Example 12 includes the portable grill of Example 11. In Example 12, the leg lock assembly further includes a tension spring coupled to a first mount and a second mount. The first mount is coupled to the release guide. The second mount is coupled to the lever. The tension spring is configured to bias the lever into the lowered lever position.

Example 13 includes the portable grill of Example 11. In Example 13, the lever is coupled to a guide post. The guide post extends through a guide slot of the release guide into a release slot of the handle. The guide post is slidable within the guide slot.

Example 14 includes the portable grill of Example 13. In Example 14, the handle is movable relative to the release guide between a lowered handle position and a raised handle position. The lever is in the lowered lever position when the handle is in the lowered handle position. The lever is in the raised lever position when the handle is in the raised handle position.

Example 15 includes the portable grill of Example 14. In Example 15, the release guide includes a release pin and the handle includes a receiver. The receiver is configured to selectively receive the release pin.

Example 16 includes the portable grill of Example 15. In Example 16, the handle is movable relative to the release guide between a retracted handle position and an extended handle position. The release pin is misaligned from the receiver when the handle is in the retracted handle position such that the release pin is not receivable in the receiver. The release pin is aligned with the receiver when the handle is in the extended handle position such that the release pin is receivable in the receiver.

Example 17 includes the portable grill of Example 16. In Example 17, misalignment between the release pin and the receiver prevents the handle from being moved from the lowered handle position into the raised handle position, and alignment between the release pin and the receiver enables the handle to be moved from the lowered handle position into the raised handle position. The release pin is configured to enter the receiver as the handle moves from the lowered handle position into the raised handle position.

Example 18 includes the portable grill of Example 16. In Example 18, the leg lock assembly further includes a tension spring coupled to a first mount and a second mount. The first mount is coupled to the release guide. The second mount is coupled to the handle. The tension spring is configured to bias the handle into the retracted handle position.

Example 19 includes the potable grill of Example 11. In Example 19, the portable grill further includes a valve and regulator assembly and a tank blocker. The valve and regulator assembly includes a tank connector configured to removably couple a fuel tank to the valve and regulator assembly. The tank blocker is movable relative to the leg lock assembly between a blocking position and a non-blocking position. The tank blocker is configured to move from the non-blocking position into the blocking position in response to the fuel tank becoming coupled to the tank connector. The tank blocker is configured to move from the blocking position into the non-blocking position in response to the fuel tank being uncoupled from the tank connector. The tank blocker is further configured to prevent the portable grill from being transitioned from the erected configuration into the collapsed configuration when the tank blocker is in the blocking position, and to enable the portable grill to be transitioned from the erected configuration into the collapsed configuration when the tank blocker is in the non-blocking position.

Example 20 includes the portable grill of Example 19. In Example 20, the tank blocker is operatively coupled to the leg lock assembly. The tank blocker includes a wire form having a blocking pin selectively positioned within a notch of the lever. The blocking pin is located within the notch when the tank blocker is in the blocking position. The blocking pin is removed from the notch when the tank blocker is in the non-blocking position. Locating the blocking pin within the notch prevents the lever from being moved from the lowered lever position into the raised lever position. Removing the blocking pin from the notch enables the lever to be moved from the lowered lever position into the raised lever position.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A portable grill configured to be transitioned between an erected configuration and a collapsed configuration, the portable grill comprising:
a frame supporting a cookbox;
a first leg unit pivotally coupled to the frame, the first leg unit including a front leg and a rear leg, the rear leg of the first leg unit spaced apart from the front leg of the first leg unit; and
a second leg unit pivotally coupled to the frame and pivotally coupled to the first leg unit, the second leg unit including:
a front leg pivotally coupled to the front leg of the first leg unit, the front leg of the second leg unit including a first segment, a second segment, and a hinge located between the first segment and the second segment of the front leg, the hinge of the front leg pivotally coupling the first segment of the front leg to the second segment of the front leg; and
a rear leg spaced apart from the front leg of the second leg unit, the rear leg of the second leg unit pivotally coupled to the rear leg of the first leg unit, the rear leg of the second leg unit including a first segment, a second segment, and a hinge located between the first segment and the second segment of the rear leg, the hinge of the rear leg pivotally coupling the first segment of the rear leg to the second segment of the rear leg.

2. The portable grill of claim 1, wherein the rear leg of the second leg unit includes a first hinge member and a second hinge member, the first hinge member coupled to the first segment of the rear leg, the second hinge member coupled to the second segment of the rear leg and pivotally coupled to the first hinge member, wherein the first hinge member and the second hinge member define the hinge of the rear leg.

3. The portable grill of claim 2, further comprising a leg lock assembly operatively coupled to the second leg unit, the leg lock assembly including a plunger having an end selectively positioned within a cavity of the second hinge member, the plunger movable relative to the first segment of the rear leg between a locked position in which the end of the plunger is positioned within the cavity and an unlocked position in which the end of the plunger is removed from the cavity.

4. The portable grill of claim 3, wherein positioning the plunger in the locked position prevents the portable grill from transitioning from the erected configuration into the collapsed configuration, and positioning the plunger in the unlocked position enables the portable grill to be transitioned from the erected configuration into the collapsed configuration.

5. The portable grill of claim 3, wherein positioning the plunger in the locked position prevents the second hinge member from rotating relative to the first hinge member, and positioning the plunger in the unlocked position enables the second hinge member to rotate relative to the first hinge member.

6. The portable grill of claim 3, wherein positioning the plunger in the locked position prevents the second segment of the rear leg from moving relative to the first segment of the rear leg, and positioning the plunger in the unlocked position enables the second segment of the rear leg to move relative to the first segment of the rear leg.

7. The portable grill of claim 3, wherein the plunger is located at least partially within the first segment of the rear leg.

8. The portable grill of claim 3, wherein the leg lock assembly further includes a tension spring coupled to a first mount and a second mount, the first mount coupled to the plunger, the second mount coupled to the rear leg of the second leg unit, the tension spring configured to bias the plunger into the locked position.

9. The portable grill of claim 3, wherein the leg lock assembly further includes a carriage coupled to the plunger, the carriage movable relative to the first segment of the rear leg between a lowered carriage position and a raised carriage position, the plunger being in the locked position when the carriage is in the lowered carriage position, the plunger being in the unlocked position when the carriage is in the raised carriage position.

10. The portable grill of claim 9, wherein the leg lock assembly further includes a release guide, a handle, and a lever, the release guide coupled to the frame, the handle movably coupled to the release guide and operatively coupled to the lever, the lever operatively coupled to the carriage.

11. The portable grill of claim 10, wherein the lever is movable relative to the release guide between a lowered lever position and a raised lever position, the carriage being in the lowered carriage position when the lever is in the lowered lever position, the carriage being in the raised carriage position when the lever is in the raised lever position.

12. The portable grill of claim 11, wherein the leg lock assembly further includes a tension spring coupled to a first mount and a second mount, the first mount coupled to the release guide, the second mount coupled to the lever, the tension spring configured to bias the lever into the lowered lever position.

13. The portable grill of claim 11, wherein the lever is coupled to a guide post, the guide post extending through a guide slot of the release guide into a release slot of the handle, the guide post slidable within the guide slot.

14. The portable grill of claim 13, wherein the handle is movable relative to the release guide between a lowered handle position and a raised handle position, the lever being in the lowered lever position when the handle is in the lowered handle position, the lever being in the raised lever position when the handle is in the raised handle position.

15. The portable grill of claim 14, wherein the release guide includes a release pin and the handle includes a receiver, the receiver configured to selectively receive the release pin.

16. The portable grill of claim 15, wherein the handle is movable relative to the release guide between a retracted handle position and an extended handle position, the release pin misaligned from the receiver when the handle is in the retracted handle position such that the release pin is not receivable in the receiver, the release pin aligned with the receiver when the handle is in the extended handle position such that the release pin is receivable in the receiver.

17. The portable grill of claim 16, wherein misalignment between the release pin and the receiver prevents the handle from being moved from the lowered handle position into the raised handle position, and alignment between the release pin and the receiver enables the handle to be moved from the lowered handle position into the raised handle position, wherein the release pin is configured to enter the receiver as the handle moves from the lowered handle position into the raised handle position.

18. The portable grill of claim 16, wherein the leg lock assembly further includes a tension spring coupled to a first mount and a second mount, the first mount coupled to the release guide, the second mount coupled to the handle, the tension spring configured to bias the handle into the retracted handle position.

19. The portable grill of claim 11, further comprising:
a valve and regulator assembly having a tank connector, the tank connector configured to removably couple a fuel tank to the valve and regulator assembly; and
a tank blocker movable relative to the leg lock assembly between a blocking position and a non-blocking position, the tank blocker configured to move from the non-blocking position into the blocking position in response to the fuel tank becoming coupled to the tank connector, the tank blocker configured to move from the blocking position into the non-blocking position in response to the fuel tank being uncoupled from the tank connector, wherein the tank blocker is further configured to prevent the portable grill from being transitioned from the erected configuration into the collapsed configuration when the tank blocker is in the blocking position, and to enable the portable grill to be transitioned from the erected configuration into the collapsed configuration when the tank blocker is in the non-blocking position.

20. The portable grill of claim 19, wherein the tank blocker is operatively coupled to the leg lock assembly, the tank blocker including a wire form having a blocking pin selectively positioned within a notch of the lever, wherein the blocking pin is located within the notch when the tank blocker is in the blocking position, and the blocking pin is removed from the notch when the tank blocker is in the non-blocking position, wherein locating the blocking pin within the notch prevents the lever from being moved from the lowered lever position into the raised lever position, and removing the blocking pin from the notch enables the lever to be moved from the lowered lever position into the raised lever position.
